(19) United States
(12) Patent Application Publication
(10) Pub. No.: US 2022/0205114 A1
(43) Pub. Date: Jun. 30, 2022

(54) DEPLOYABLE, REMOTELY-CONTROLLED, PURE HYPOCHLOROUS ACID MANUFACTURING SYSTEM AND METHOD

(71) Applicant: Briotech, Inc., Woodinville, WA (US)

(72) Inventors: Daniel J Terry, Mill Creek, WA (US); Jeffrey F Williams, Langley, WA (US); Robert Day, Seattle, WA (US)

(21) Appl. No.: 17/396,018

(22) Filed: Aug. 6, 2021

Related U.S. Application Data
(60) Provisional application No. 63/062,287, filed on Aug. 6, 2020.

(51) Int. Cl. C25B 1/26; C25B 15/023; C25B 9/17; C25B 15/08; C25B 9/65

(52) U.S. Cl. CPC C25B 1/26; C25B 15/023; C25B 9/65; C25B 15/085; C25B 9/17

(57) ABSTRACT

A HOCl manufacturing system is disclosed for production of high potency, safe, consistently pure, stable, authentic HOCl in a deployable, portable, high volume, localized manufacturing unit. The electrolysis method uses a deployable, remote-controlled manufacturing system. The method includes: controlling water flow rate into an electrolysis chamber by providing feedback controlled water pressure; applying feedback controlled current to the electrolysis chamber via an adjustable and high-current power supply; adding sodium chloride brine, via a feedback controlled actuator, to an anode chamber inlet and creating an aqueous mixture; adding sodium hydroxide, via a feedback controlled actuator, to the aqueous mixture; and producing aqueous hypochlorous acid free from hypochlorites, phosphates, oxides, and stabilizers.

### TECHNICAL FIELD

The present disclosure generally relates to systems and methods for the manufacture of pure hypochlorous acid and, particularly, to deployable, remotely-controlled systems and methods for the manufacture of pure hypochlorous acid.

### BACKGROUND

### Description of the Related Art

Communities across the world are now challenged by enormous problems: pandemics, non-addressable infections, non-healing wounds, a global shortage of clean drinking water, and looming food insecurity. Countries around the world are additionally stressed by the burden of supporting aging populations. Half of the world has no access to healthcare, and a scarcity of potable water and power affects one fifth of the global population. A solution resides in a composition identified as hypochlorous acid (HOCl) that has been known as a disinfectant but has not found widespread adoption due to the highly unstable nature of the molecule. Equipment manufacturers across the globe have not addressed challenges associated with consistency of HOCl production over time, ease of use, product stability and cost realities of providing HOCl as a solution. The lack of consistency in HOCl manufacture and failure of widespread adoption provide evidence of the failure of existing systems.

Hypochlorous acid (HOCl) has been known and generally accepted to be useful for its beneficial medical, food disinfection, and infection-control/therapeutic applications. As a component of the Reactive Oxygen Species (ROS) response of human and animal cells to infection and injury, it is known to be unstable with a short life span in vivo. HOCl, in its manufactured presentation throughout the world, is typically an undefined mixture of reactive oxidant species, a hybrid composition consisting of various components of aqueous molecular chlorine, plus the benign but highly effective HOCl, together with one or more of hypochlorite, chlorates, chlorites, perchlorates and possibly short acting ozone, peroxides, and unidentifiable free radicals (i.e., sensu lato, meaning an HOCL mixture with one or more of the contaminants listed above). Some of these components are known to be cytotoxic and potentially dangerous. Where any amount of hypochlorite is available in a HOCl composition, a chemical reaction occurs that rapidly accelerates the conversion of HOCl to hypochlorite and other forms of aqueous chlorine. HOCl is regularly mischaracterized and mislabeled as being equivalent to the crude mixed oxidant products of uncontrolled manufacturing processes, even though authentic pure HOCl (i.e., sensu stricto, meaning a HOCl mixture with no amount of hypochlorites, mixed oxidants, or other contaminants listed above) is a singular molecular entity. Notably, pure water and saline are not considered contaminants in this situation.

HOCl is often produced through pH adjustment of hypochlorite solutions using organic or inorganic compounds, but the process is notoriously difficult to control at an industrial scale in order to arrive at a consistent endpoint, resulting in unreliable and ill-defined products, again frequently mischaracterized as authentic pure stable HOCl instead, when it is actually a HOCl mixed hypochlorite/oxidant solution. HOCl may also be produced in chlorine generators (frequently mislabeled as HOCl generators) through onsite electrolysis producing often poorly defined aqueous low pH mixtures that contain excessive amounts of molecular chlorine gas (Cl₂) species which release an extremely hazardous gas (chlorine at a pH of 1-4). However, typical mixed oxidant species containing HOCl produced in electrolysis is often characterized by shortened shelf life and/or the presence of components that degrade into bleach (e.g., sodium hypochlorite, NaClO) with time.

Additionally, many manufacturers promote their HOCl products as being of “neutral pH” which, by definition, puts them in the category of mixtures having a pH of 7.4 in which approximately 50% of aqueous chlorine must be present as hypochlorite. These mixed oxidants are unstable hypochlorite-containing mixtures that do not impart the efficacy and safety of the singular molecular entity represented by authenticated pure stable HOCl products. These mixtures are thus not only unsafe but are known to be 100 times less effective than pure HOCl having an equivalent Cl content.

Electrolytically-generated mixed-oxidant chlorine species striving for a useful percentage of HOCl, with or without buffering agents, are well established in the industry, but they are far less effective than pure HOCl. These electrolytically-generated mixed-oxidant chlorine species are unstable, and potentially dangerous if they emit Cl₂ gas. For safety, existing processes have often been applied on site with provisos requiring immediate use, or needing additives such as chlorine stabilizers and stabilizing buffers. Those buffers create a recognized level of impurity and also underlie label-acknowledged levels of hypochlorite.

Manufacture of HOCl by electrolysis has heretofore been unable to generate aqueous formulations with sufficient stability for a wider array of practical uses without the incorporation of buffering systems, and/or a range of stabilizing entities, including metal cations, periodate, phosphate buffers, carbonate buffers, and organic compounds with halogen stabilizing abilities.

All of the additives and chemical stabilizers conventionally employed to support the maintenance of HOCl in active form over practically useful storage periods depend on the presence of other species of aqueous chlorine, such as hypochlorite and chlorite/chlorate, or chlorine, depending on the chemical intervention chosen, or lead to their appearance in the solution as a result of the onset of decay. Many of these constituents contribute toxic effects on cells and tissues to the formulations that limit their usefulness in medical procedures. Aqueous species of halogens other than the hypohalous acids, HOCl and HOBr, all deliver detrimental and often corrosive impacts on environmental surfaces that make them less than ideal for practical purposes.

An answer is needed to the problems that accompany HOCl production, of volume-limiting, dangerous, unreliable and difficult nature of chemical pH adjustment (acid titration), and the inconsistency of mixed-oxidant products that are fraudulently promoted as HOCl. Additionally, an answer is needed to the historical problem of the generation of crude undefined solutions containing some HOCl made in electrolysis equipment, which provide chemical mixtures that are both unreliable in their effect, and potentially dangerous.

Furthermore, those mixed oxidants lose potency over time and as they degrade across the pH spectrum. Therefore, typical HOCl produced as mixed oxidant complexes (i.e., sensu lato) is less stable, less consistent, less reliable, less potent, and less likely to be adopted for its most high value applications. Current technologies produce a chlorine/HOCl/bleach mixture. The present disclosure addresses these needs and provides other related technological improvements.

### BRIEF SUMMARY

Briefly stated, the disclosed authentic HOCl Manufacturing System is accessible and remotely controllable after remote deployment throughout the world for real-time diagnostics, control, and monitoring utilizing one or more of Ethernet, Cellular, or Satellite uplink technologies. The authentic HOCl Manufacturing System provides assurance of quality by any user anywhere that the system is deployed.

The system provides for global deployment of homogeneous HOCl production system that involves complex, high-level process-controlled manufacturing, but that may be operated and controlled completely remotely. The authentic HOCl Manufacturing System may automatically run a high-production pure hypochlorous acid (HOCl) electrochemical manufacturing system using internal or external energy sources and remotely controlled communication connectivity.

An electrolysis method using a deployable, remote-controlled manufacturing system that includes: in response to a remote activation, controlling water flow rate into an electrolysis chamber, by providing feedback controlled water pressure; in response to the remote activation, applying feedback controlled current to the electrolysis chamber via an adjustable and high-current power supply; in response to the remote activation, adding sodium chloride brine, via a feedback controlled actuator, to an anode chamber inlet and creating an aqueous mixture; in response to the remote activation, adding sodium hydroxide, via the feedback controlled actuator, to the aqueous mixture; and producing aqueous hypochlorous acid at an anode chamber outlet, and aqueous sodium hydroxide solution at a cathode chamber outlet, wherein the aqueous hypochlorous acid is free from hypochlorites, phosphates, oxides, and stabilizers.

In another aspect of some embodiments of this electrolysis method, the electrolysis chamber utilizes dynamic vortex implosion inputs that are injected into a laminar flow plenum and rotate water inline to drive energy into the water structure. In still another aspect of some embodiments, the laminar flow plenum is alternating platinum and ruthenium-iridium oxide encased.

In some embodiments, adding the sodium hydroxide to the aqueous mixture may further include adding the sodium hydroxide to the anode chamber inlet from the cathode chamber outlet via a de-gassing chamber and pump. In other embodiments, adding the sodium hydroxide to the aqueous mixture further includes adding the sodium hydroxide from an aqueous solution independent of an electrolysis mechanism.

In one or more embodiments, the aqueous Hypochlorous acid produced at the anode chamber outlet is directed to an anolyte buffer tank. In another aspect of one or more embodiments, the aqueous sodium hydroxide solution produced at the cathode chamber outlet is directed to a catholyte buffer tank. In still another aspect of one or more embodiments, the aqueous Hypochlorous acid is free from metal cations, periodate, phosphate buffers, carbonate buffers, and organic compounds with halogen stabilizing abilities. In yet another aspect of one or more embodiments, the method does not include titration. In still another aspect of one or more embodiments, the method does not use any acid as an input component.

In one or more embodiments, the aqueous hypochlorous acid has a Raman spectroscopy value range of 720 centimeters⁻¹-740 centimeters⁻¹. In another aspect of one or more embodiments, the pH balance of the aqueous hypochlorous acid is controllable using one or more of the feedback-controlled water pressure, a feedback controlled electric current, a feedback controlled sodium chloride, and a feedback controlled sodium hydroxide. In still another aspect of one or more embodiments, the parts per million (PPM) of HOCl in the aqueous hypochlorous acid is controllable using one or more of the feedback controlled water pressure, a feedback controlled electric current, a feedback controlled sodium chloride, and a feedback controlled sodium hydroxide.

In another aspect of one or more embodiments, the salt concentration of the aqueous hypochlorous acid is controllable using one or more of the feedback controlled water pressure, a feedback controlled electric current, a feedback controlled sodium chloride, and a feedback controlled sodium hydroxide. In still another aspect of one or more embodiments, the oxidative reduction potential (ORP) of the aqueous hypochlorous acid is controllable using one or more of the feedback controlled water pressure, a feedback controlled electric current, a feedback controlled sodium chloride, and a feedback controlled sodium hydroxide. In yet another aspect of one or more embodiments, the amount of free chlorine concentration in the aqueous hypochlorous acid is controllable using one or more of the feedback controlled water pressure, a feedback controlled electric current, a feedback controlled sodium chloride, and a feedback controlled sodium hydroxide.

In one or more embodiments, hydrogen gas may be expressed at the cathode chamber outlet of the electrolysis chamber, and a chlorine and oxygen gas mixture are expressed at the anode chamber outlet of the electrolysis chamber. The hydrogen gas may be approximately 1000:1 air to hydrogen mixture, and safe to vent. In some embodiments, the chlorine and oxygen gas mixture may be exchanged in a closed system which includes activated carbon block adsorption filters. The activated carbon block adsorption filters may be monitored by a chlorine sensor. A water supply may have been filtered for partial dissolved solids. A water supply may have been treated to neutralize or remove pathogens. A water supply may have been de-ionized to remove insoluble metals.

In another embodiment, an electrolysis method using a deployable, remote-controlled, hypochlorous acid (HOCl) manufacturing system may be summarized as including delivering water from a water supply; providing feedback controlled water pressure to an anolyte metering valve and a catholyte metering valve; controlling water flow rate into an electrolysis chamber, via an anode chamber inlet and a cathode chamber inlet of the electrolysis chamber; during water flow into the electrolysis chamber, applying current to the electrolysis chamber via an adjustable and feedback controlled high-current power supply; adding sodium chloride brine, via a feedback controlled pump, to the anode chamber inlet and creating an aqueous mixture; adding sodium hydroxide, via the feedback controlled pump, to the aqueous mixture; and producing aqueous hypochlorous acid at an anode chamber outlet, and aqueous sodium hydroxide solution at a cathode chamber outlet, wherein the aqueous hypochlorous acid is free from hypochlorites, phosphates, oxides, and stabilizers.

In some embodiments, adding the sodium hydroxide to the aqueous mixture further includes adding the sodium hydroxide to the anode chamber inlet from the cathode chamber outlet via a de-gassing chamber and pump. In other embodiments, adding the sodium hydroxide to the aqueous mixture further includes adding the sodium hydroxide from an aqueous solution independent of an electrolysis mechanism.

In one or more embodiments, the aqueous hypochlorous acid produced at the anode chamber outlet is directed to an anolyte buffer tank. In another aspect of one or more embodiments, the aqueous sodium hydroxide solution produced at the cathode chamber outlet is directed to a catholyte buffer tank. In still another aspect of one or more embodiments, the aqueous hypochlorous acid is free from metal cations, periodate, phosphate buffers, carbonate buffers, and organic compounds with halogen stabilizing abilities. In yet another aspect of one or more embodiments, the method does not include titration. In still another aspect of one or more embodiments, the method does not use any acid as an input component.

In one or more embodiments, the aqueous hypochlorous acid has a Raman spectroscopy value range of 720 centimeters⁻¹-740 centimeters⁻¹. In another aspect of one or more embodiments, the pH balance of the aqueous hypochlorous acid is controllable using one or more of the feedback-controlled water pressure, a feedback controlled electric current, a feedback controlled sodium chloride, and a feedback controlled sodium hydroxide. In still another aspect of one or more embodiments, the parts per million (PPM) of HOCl in the aqueous hypochlorous acid is controllable using one or more of the feedback controlled water pressure, a feedback controlled electric current, a feedback controlled sodium chloride, and a feedback controlled sodium hydroxide.

In another aspect of one or more embodiments, the salt concentration of the aqueous hypochlorous acid is controllable using one or more of the feedback controlled water pressure, a feedback controlled electric current, a feedback controlled sodium chloride, and a feedback controlled sodium hydroxide. In still another aspect of one or more embodiments, the oxidative reduction potential (ORP) of the aqueous hypochlorous acid is controllable using one or more of the feedback controlled water pressure, a feedback controlled electric current, a feedback controlled sodium chloride, and a feedback controlled sodium hydroxide. In yet another aspect of one or more embodiments, the amount of free chlorine concentration in the aqueous hypochlorous acid is controllable using one or more of the feedback controlled water pressure, a feedback controlled electric current, a feedback controlled sodium chloride, and a feedback controlled sodium hydroxide.

In one or more embodiments, hydrogen gas is expressed at the cathode chamber outlet of the electrolysis chamber, and a chlorine and oxygen gas mixture are expressed at the anode chamber outlet of the electrolysis chamber. The hydrogen gas may be approximately 1000:1 air to hydrogen mixture, and safe to vent. In some embodiments, the chlorine and oxygen gas mixture may be exchanged in a closed system which includes activated carbon block adsorption filters. The activated carbon block adsorption filters may be monitored by a chlorine sensor.

An electrolysis method may be summarized as including controlling water flow rate into an electrolysis chamber using water pressure; applying current to the electrolysis chamber via a power supply; adding sodium chloride brine to an anode chamber inlet and creating an aqueous mixture; adding sodium hydroxide to the aqueous mixture; and producing aqueous hypochlorous acid at an anode chamber outlet, and aqueous sodium hydroxide solution at an cathode chamber outlet, wherein the aqueous hypochlorous acid is free from hypochlorites, phosphates, oxides, and stabilizers.

In another aspect of some embodiments of this electrolysis method, the electrolysis chamber utilizes dynamic vortex implosion inputs that are injected into a laminar flow plenum. In still another aspect of some embodiments, the laminar flow plenum is alternating platinum and ruthenium-iridium oxide encased.

In still another embodiment, an electrolysis system using a deployable, remote-controlled manufacturing system may be summarized as including a monitoring system that monitors sensors in the system; a communication system that transmits data from the monitored sensors and receives instructions; and a control system including a processor and a memory storing computer instructions that, when executed by the processor with the received instructions, cause the processor to: control water flow rate into an electrolysis chamber, by providing feedback controlled water pressure; apply feedback controlled current to the electrolysis chamber via an adjustable and high-current power supply; add sodium chloride brine, via a feedback controlled actuator, to an anode chamber inlet and creating an aqueous mixture; add sodium hydroxide, via the feedback controlled actuator, to the aqueous mixture; and produce aqueous hypochlorous acid at an anode chamber outlet, and aqueous sodium hydroxide solution at a cathode chamber outlet, wherein the aqueous hypochlorous acid is free from hypochlorites, phosphates, oxides, and stabilizers.

In another aspect of some embodiments of this electrolysis system, the electrolysis chamber utilizes dynamic vortex implosion inputs that are injected into a laminar flow plenum. In still another aspect of some embodiments, the laminar flow plenum is alternating platinum and ruthenium-iridium oxide encased.

In yet another embodiment, an electrolysis system using a deployable, remote-controlled manufacturing system may be summarized as including one or more deployable, remote-controlled manufacturing systems, and a basecamp unit including a monitoring system that monitors the one or more deployable, remote-controlled manufacturing systems.

In one or more embodiments, each deployable, remote-controlled manufacturing system including a monitoring system that monitors sensors in the system; a communication system that transmits data from the monitored sensors and receives instructions; and a control system including a processor and a memory storing computer instructions that, when executed by the processor with the received instructions, cause the processor to: control water flow rate into an electrolysis chamber, by providing feedback controlled water pressure; apply feedback controlled current to the electrolysis chamber via an adjustable and high-current power supply; add sodium chloride brine, via a feedback controlled actuator, to an anode chamber inlet and creating an aqueous mixture; add sodium hydroxide, via the feedback controlled actuator, to the aqueous mixture; and produce aqueous hypochlorous acid at an anode chamber outlet, and aqueous sodium hydroxide solution at a cathode chamber outlet, wherein the aqueous hypochlorous acid is free from hypochlorites, phosphates, oxides, and stabilizers.

In another aspect of some embodiments of this manufacturing system, the electrolysis chamber utilizes dynamic vortex implosion inputs that are injected into a laminar flow plenum. In still another aspect of some embodiments, the laminar flow plenum is alternating platinum and ruthenium-iridium oxide encased.

In one or more embodiments, the basecamp unit includes: a communication system that transmits data to and from the one or more deployable, remote-controlled manufacturing systems; and a control system including a processor and a memory storing computer instructions that, when executed by the processor with received instructions, cause the processor to: receive information from the one or more deployable, remote-controlled manufacturing systems; and send instructions to the one or more deployable, remote-controlled manufacturing systems.

In still another embodiment, a deployable, remote-controlled, hypochlorous acid (HOCl) electrolysis manufacturing system may be summarized as including a water supply tank from which water is obtained; a brine water supply tank from which brine water is obtained; an electrolysis chamber having an anolyte chamber inlet, a catholyte chamber inlet, an anode chamber outlet, and a cathode chamber outlet; a conduit from the water supply tank to a catholyte metering valve of the electrolysis chamber; a conduit from the brine water supply tank to an anolyte metering valve of the electrolysis chamber; a supply pump associated with the conduit from the water supply tank to the catholyte metering valve of the electrolysis chamber; a saline metering pump associated with the conduit from the brine water supply tank to the anolyte metering valve of the electrolysis chamber; a high-current power supply that applies current to the electrolysis chamber; and a control system including a processor and a memory storing computer instructions that, when executed by the processor with received instructions, cause the processor to: control water flow rate into the electrolysis chamber, by providing feedback controlled water pressure; apply feedback controlled current to the electrolysis chamber via an adjustable and high-current power supply; add sodium chloride brine, via a feedback controlled actuator, to an anode chamber inlet and create an aqueous mixture; and add sodium hydroxide, via the feedback controlled actuator, to the aqueous mixture, wherein aqueous hypochlorous acid is produced at the anode chamber outlet, and aqueous sodium hydroxide solution is produced at the cathode chamber outlet, wherein the aqueous hypochlorous acid is free from hypochlorites, phosphates, oxides, and stabilizers.

In still another embodiment, a deployable, remote-controlled, hypochlorous acid (HOCl) electrolysis manufacturing system may be summarized as including: an electrolysis chamber; a high-current power supply that applies current to the electrolysis chamber; and a control system including a processor and a memory storing computer instructions that, when executed by the processor, cause the processor to: control water flow rate into the electrolysis chamber, by providing feedback controlled water pressure; apply feedback controlled current to the electrolysis chamber via an adjustable and high-current power supply; add sodium chloride brine, via a feedback controlled actuator, to an anode chamber inlet and create an aqueous mixture; and add sodium hydroxide, via the feedback controlled actuator, to the aqueous mixture, wherein aqueous hypochlorous acid is produced at the anode chamber outlet, and aqueous sodium hydroxide solution is produced at the cathode chamber outlet, wherein the aqueous hypochlorous acid is free from hypochlorites, phosphates, oxides, and stabilizers.

In still another embodiment, an electrolysis method using a hypochlorous acid (HOCl) manufacturing system may be summarized as including: providing feedback controlled water pressure to an anolyte metering valve and a catholyte metering valve; controlling a flow rate of raw untreated seawater without additional salts, buffers, agents or catalysts into an electrolysis chamber, via a feedback controlled pump, through one or more of an anode chamber inlet and a cathode chamber inlet of the electrolysis chamber; during water flow into the electrolysis chamber, applying current to the electrolysis chamber via an adjustable and feedback controlled high-current power supply; and producing aqueous hypochlorous acid at an anode chamber outlet, wherein the aqueous hypochlorous acid is free from hypochlorites, phosphates, oxides, and stabilizers.

In another aspect of some embodiments of this electrolysis method, the electrolysis chamber utilizes dynamic vortex implosion inputs that are injected into a laminar flow plenum. In still another aspect of some embodiments, the laminar flow plenum is alternating platinum and ruthenium-iridium oxide encased.

In one or more embodiments, the aqueous hypochlorous acid produced by the hypochlorous acid (HOCl) manufacturing system is freezable up to four times without detriment to its stability and effectiveness as a virucidal and biocidal. In another aspect of some embodiments, the aqueous hypochlorous acid produced by the hypochlorous acid (HOCl) manufacturing system is freezable up to four times without having a detectable loss of oxidative reduction potential (ORP) greater than 10%. In still other embodiments, the aqueous hypochlorous acid produced by the hypochlorous acid (HOCl) manufacturing system is heatable up to 80 C without detriment to its stability and effectiveness as a virucidal and biocidal. In another aspect of some embodiments, the aqueous hypochlorous acid produced by the hypochlorous acid (HOCl) manufacturing system is heatable up to 80 C without having a detectable loss of oxidative reduction potential (ORP) greater than 10%. In other embodiments, the hypochlorous acid (HOCl) manufacturing system is deployed on a ship.

In yet other embodiments, a hypochlorous acid (HOCl) electrolysis manufacturing system may be summarized as including: an electrolysis chamber; a high-current power supply that applies current to the electrolysis chamber; and a control system including a processor and a memory storing computer instructions that, when executed by the processor, cause the processor to: provide feedback controlled water pressure to an anolyte metering valve and a catholyte metering valve; control a flow rate of raw untreated seawater without additional salts, buffers, agents or catalysts into the electrolysis chamber, via a feedback controlled pump, through one or more of an anode chamber inlet and a cathode chamber inlet of the electrolysis chamber; during water flow into the electrolysis chamber, apply current to the electrolysis chamber via an adjustable and feedback controlled high-current power supply; and produce aqueous hypochlorous acid at an anode chamber outlet, wherein the aqueous hypochlorous acid is free from hypochlorites, phosphates, oxides, and stabilizers.

In some other embodiments, a deployable, remote-controlled HOCl generation system may be summarized as including: a monitoring system that monitors sensors in the system; a communication system that transmits data from the monitored sensors and receives instructions; and a control system that incorporate one or more of artificial neural networks (ANN) and machine learning (ML) models, the control system including a processor and a memory storing computer instructions that, when executed by the processor with the received instructions, cause the processor to: control water flow rate into an electrolysis chamber, by providing feedback controlled water pressure; apply feedback controlled current to the electrolysis chamber via an adjustable and high-current power supply; add sodium chloride brine, via a feedback controlled actuator, to an anode chamber inlet and creating an aqueous mixture add sodium hydroxide, via the feedback controlled actuator, to the aqueous mixture; monitor multiple, linked effects of each control parameter in real time to identify and modify constantly changing control parameters; and produce aqueous hypochlorous acid, wherein the aqueous hypochlorous acid is free from hypochlorites, phosphates, oxides, and stabilizers; wherein one or more of artificial neural networks and machine learning models utilize a combination of ML algorithms and real-time closed loop adaptive learning controls to adjust multiple feedback control loops in relation to each other.

In another aspect of some embodiments, the one or more artificial neural networks and machine learning models access a set of machine learning models based on historic production data that influence the one or more artificial neural networks and real time machine learning models, wherein the one or more artificial neural networks and machine learning models control multiple feedback control loop cycles and enable the system to self-correct and adapt for changes in the HOCl generation process during a production run. In still another aspect of some embodiments, the combination of machine learning algorithms and real-time closed loop adaptive learning controls include particle swarm optimization. In yet another aspect of some embodiments, wherein the one or more artificial neural networks and machine learning models predict future behavior of the pH adjustment parameters and perform real-time control of the pH adjustment loops, electrolysis current, and brine.

In another aspect of some embodiments of this HOCl generation system, the electrolysis chamber utilizes dynamic vortex implosion inputs that are injected into a laminar flow plenum. In still another aspect of some embodiments, the laminar flow plenum is alternating platinum and ruthenium-iridium oxide encased.

In still other embodiments, electrolysis method using a hypochlorous acid (HOCl) manufacturing system may be summarized as including: accessing a control system that incorporates one or more of artificial neural networks and machine learning models, the control system including a processor and a memory storing computer instructions; controlling water flow rate into an electrolysis chamber, by providing feedback controlled water pressure; applying feedback controlled current to the electrolysis chamber via an adjustable and high-current power supply; adding sodium chloride brine, via a feedback controlled actuator, to an anode chamber inlet and creating an aqueous mixture; adding sodium hydroxide, via the feedback controlled actuator, to the aqueous mixture; monitoring multiple, linked effects of each control parameter in real time to identify and modify constantly changing control parameters; and producing aqueous hypochlorous acid, wherein the aqueous hypochlorous acid is free from hypochlorites, phosphates, oxides, and stabilizers; wherein the one or more of artificial neural networks and machine learning models utilize a combination of ML algorithms and real-time closed loop adaptive learning controls to adjust multiple feedback control loops in relation to each other.

In another aspect of some embodiments of this electrolysis method, the electrolysis chamber utilizes dynamic vortex implosion inputs that are injected into a laminar flow plenum. In still another aspect of some embodiments, the laminar flow plenum is alternating platinum and ruthenium-iridium oxide encased.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is a Raman spectrum that shows pure, stable, authenticated HOCl having a singular measurable peak as measured by Raman spectroscopy at 728-732 centimeters⁻¹.

FIG. 2 shows the percentage representation of chlorine that is present as HOCl as a function of pH with substantially all available chlorine present as pure, stable, authentic HOCl at pH between 4.0-5.33.

FIG. 3 is a perspective view of a deployable, remote controlled, secure manufacturing unit for pure, stable, authentic HOCl.

FIG. 4 is a Piping and Instrumentation diagram of the components (e.g., piping, valves, gauges, pumps, tanks, etc.) and process flow in an embodiment of the authentic HOCl manufacturing system and method.

FIG. 5 is a schematic of the control panel in an embodiment of the authentic HOCl manufacturing system and method for remotely controlling the components and process flow.

FIG. 6 is a diagram of a fluid pipe showing guide-vanes for use in one or more embodiments of the authentic HOCl manufacturing system and method.

FIG. 7 is a diagram of a fluid pipe for inline induction of vortex energy for use in one or more embodiments of the authentic HOCl manufacturing system and method.

### DETAILED DESCRIPTION

Persons of ordinary skill in the art will understand that the present disclosure is illustrative only and not in any way limiting. Each of the features and teachings disclosed herein can be utilized separately or in conjunction with other features and teachings to provide a deployable, remote-controlled, hypochlorous acid (HOCl) electrolysis manufacturing system and method. Representative examples utilizing many of these additional features and teachings, both separately and in combination, are described in further detail with reference to the attached figures. This detailed description is merely intended to teach a person of skill in the art further details for practicing aspects of the present teachings, and is not intended to limit the scope of the claims. Therefore, combinations of features disclosed in the detailed description may not be necessary to practice the teachings in the broadest sense, and are instead taught merely to describe particularly representative examples of the present teachings.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities, and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” “configuring,” or the like, refer to the actions and processes of a computer system, or similar electronic computing device, that manipulate and transform data represented as physical (electronic) quantities within the computer system's registers and memories into other data similarly represented as physical quantities within the computer system memories or registers or other such information storage, transmission or display devices.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

Unless the context requires otherwise, throughout the specification and claims which follow, the word “comprise” and variations thereof, such as “comprises” and “comprising,” are to be construed in an open, inclusive sense, that is, as “including, but not limited to.” Reference throughout this specification to “one implementation” or “an implementation” means that a particular feature, structures, or characteristics may be combined in any suitable manner in one or more implementations.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise. The headings and Abstract of the Disclosure provided herein are for convenience only and do not interpret the scope or meaning of the implementations.

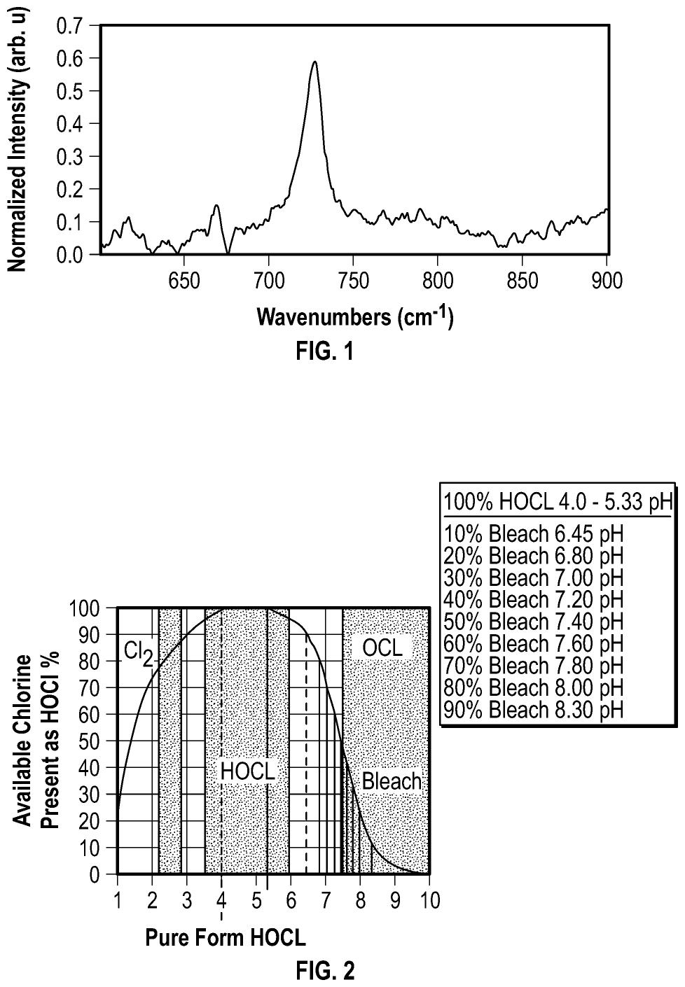

Referring now to FIGS. 1 and 2, FIG. 1 shows a Raman spectrum of pure, stable, authenticated HOCl as measured by Raman spectroscopy, while FIG. 2 shows the percentage representation of chlorine that is present as HOCl as a function of pH, with pure, stable, authenticated HOCl representing substantially all available chlorine at pH between 4.0-5.33. The HOCl manufacturing system and method 100 is a novel hypochlorous acid (HOCl) production system that uses remote manufactured control for production of an authentically pure HOCl that contains no detectable molecules of hypochlorite as measured by Raman spectroscopy analysis at 720-740 centimeters⁻¹, optimally at 728-732 centimeters⁻¹. The absence of detectable hypochlorite contributes to stability by the avoidance of acceleration of reactions that degrade HOCl, and where these characteristics of a singular 720-740 centimeters⁻¹ Raman peak, a complete HOCl presentation between pH 4.0-5.33 and state of isotonicity. Such stability relates to the primary values in hypochlorous acid shelf stability in terms of the concentration of HOCl in parts per million, Oxidation Reduction Potential (ORP), pH and thermal tolerance from −80° C. to 100° C.

The HOCl manufacturing system and method 100 controls the production of authentically pure HOCl without need of trained personnel. In widely diverse environmental conditions, locales, and inputs, the HOCl manufacturing system and method 100 maintains optimal ranges of pH, ORP, active ingredient (Cl) and purity through ethernet-, cellular, or satcom-connected and controlled electrolysis. The HOCl manufacturing system and method 100 includes features determining automated processes through feedback loops in water filtration, pressure modulation, ingress and egress flow, specifically-created turbulence specificity, electrical amperage, brine input concentrations and magnetic inputs so as to provide real time pharmaceutical-level synthesis of HOCl in globally remote environments with untrained personnel.

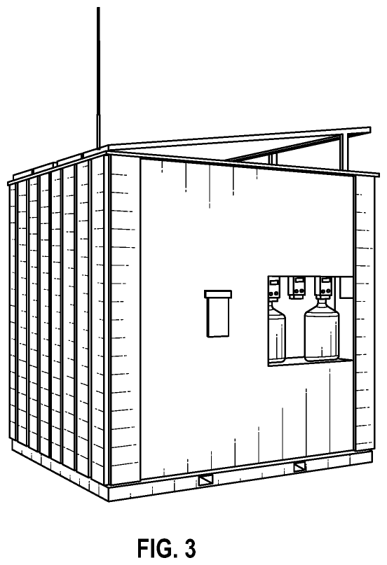

FIG. 3 shows a deployable, remote controlled, secure HOCl manufacturing system and method 100 for pure, stable, authentic hypochlorous acid (HOCl). The HOCl manufacturing system and method 100 produces pure, authentic, and stable hypochlorous acid without stabilizing buffers or aqueous chlorine, at high-volume, in a uniquely safe and continually sensor-monitored process. The HOCl manufacturing system and method 100 implements an electrochemical process system that produces an authentic and stabilized hypochlorous acid. The HOCl manufacturing system and method 100 provides verifiable synthesis of authentic, stabilized hypochlorous acid that may, by way of non-limiting theory and according to certain embodiments, supplement, supplant, replace, or beneficially introduce HOCl in contexts where HOCl produced by human neutrophils is absent, insufficient, or otherwise unavailable. The HOCl manufacturing system and method 100 is a deployable unit that may be positioned anywhere in the world and can function using remotely sensor-monitored and controlled processes.

The HOCl manufacturing system and method 100 includes a process control center, a remote communications center, a security center, a power center, and I/O center. The process control center, which is described in further detail below, monitors and controls the manufacturing process of the pure, stable, authentic hypochlorous acid (HOCl). The remote communications center enables authorized personnel to remotely monitor and control the manufacturing process of the pure, stable, authentic hypochlorous acid (HOCl) from another remote location. The security center and it functions, which are described in further detail below, provide and manage various security features related to the manufacturing process of the pure, stable, authentic hypochlorous acid (HOCl) and the structure of the deployed HOCl manufacturing system itself. The power center of the HOCl manufacturing system and method 100 regulates the power of the system. In some embodiments, the HOCl manufacturing system and method 100 is sustainably powered with solar panels and other renewable energy devices that feed a battery appliance (e.g., a Powerwall battery). Some embodiments of the HOCl manufacturing system and method 100 enable excess energy to be made available to a local community either for free or as a paid service. The I/O center of the HOCl manufacturing system and method 100 may control and manage a User Interface Portal that enables the dispensing and sale of pure, stable, authentic hypochlorous acid (HOCl) by cell phone payment, cash, or credit card.

The functionality produced by these centers enables the HOCl manufacturing system and method 100 to be delivered virtually anywhere on earth and run at pharmaceutical quality levels by individuals without skill in machinery or chemistry. The HOCl manufacturing system and method 100 requires little to no maintenance and produces high volumes of pharmaceutical quality HOCl. As shown in FIG. 3, in some embodiments the HOCl manufacturing system and method 100 has a compact footprint that makes it portable and scaleable for per unit and multi-unit production. In one or more embodiments, the HOCl manufacturing system and method 100 may operate with only readily available saltwater inputs and provide high volumes of pure, stable, authentic hypochlorous acid (HOCl) via distributed localized manufacturing.

In some embodiments, the communications center of the HOCl manufacturing system and method 100 provides remote access to the system through a local Virtual Private Network, and optionally, Satellite Links, Cellular or Wired or Wireless Ethernet connectivity. In embodiments that utilizes Satellite connectivity, the HOCl manufacturing system and method 100 may be deployed and functional virtually anywhere on earth. Additionally, in embodiments that utilizes Satellite connectivity, the HOCl manufacturing system and method 100 may provide local community centered Internet and cell phone connectivity. Such remote connectivity by the HOCl manufacturing system and method 100 is preferentially dynamic. In some embodiments, the HOCl manufacturing system and method 100 may be sporadically accessed in periodic downloads for monitoring operations, validation of preventative maintenance, and tolling fee indices of the system.

In other embodiments, the HOCl manufacturing system and method 100 utilizes VPN technology, which is certified to handle credit cards (PCI) to protect the data in flight. Additionally, other embodiments of the HOCl manufacturing system and method 100 that utilize VPN technology may leverage the Wi-Fi of an airport or localized facilities. In another aspect of the communications center, other cybersecurity technologies are implemented to ensure that the HOCl manufacturing system and method 100 is not tampered with from a cyber-attack.

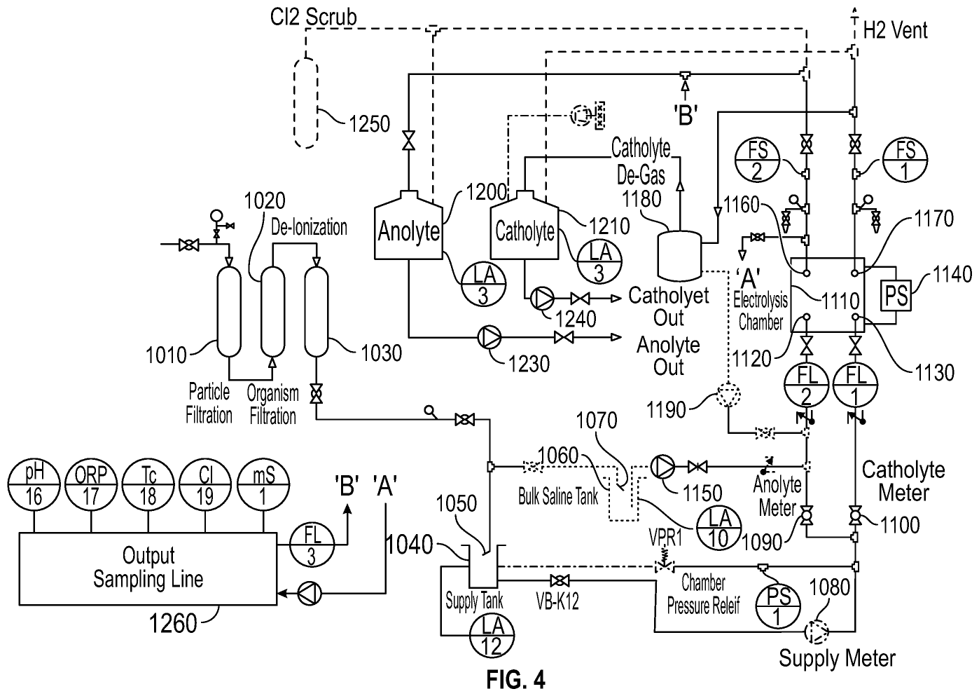

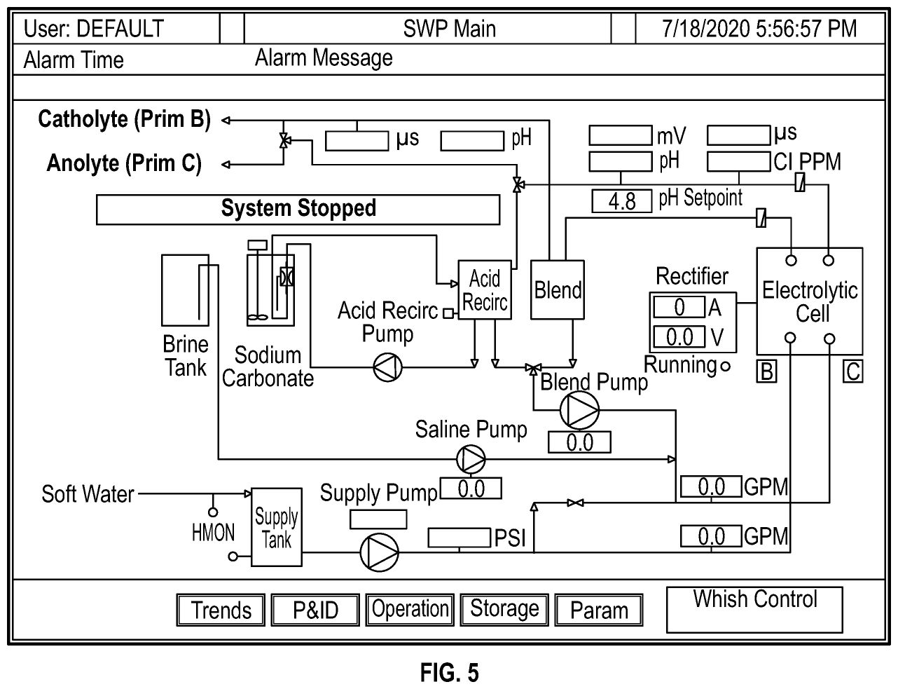

In another aspect of some embodiments, HOCl manufacturing system and method 100 also includes a water purification system producing large amounts (e.g., 3000 gallons per day, 5000 gallons per day, and the like) of clean drinking water. In one or more embodiments, the water purification system is a WARP (Water and Renewable Power) system that is self-powered, low-cost, rugged, and reliable. In some embodiments, the water purification system uses a series of spin-down filters of optionally 152, 104, 61, 30, 15, 20, 10, 5, 1 and 0.5 micron filters some of which may be in preferential embodiments be made of zeta-charged electro-absorptive aluminum, coupled with UV filtration, Silecte Quantum Disinfection and Carbon Block filtration such that water meets WHO ‘Guidelines for Drinking-water Quality’. In some embodiments of the HOCl manufacturing system and method 100, electrically charged membranes, submicron media filters, and deionization are used to assure appropriate water quality minimizing collateral electro-chemical reactions in the electrolysis process. Accordingly, some embodiments of the HOCl manufacturing system and method 100 provide both HOCl production and clean drinking water for a local community even when sourced from local water. Referring now to FIGS. 4 and 5, FIG. 4 is a piping and instrumentation diagram of the components (e.g., piping, valves, gauges, pumps, tanks, etc.) and process flow in an embodiment of the HOCl manufacturing system and method 100, while FIG. 5 is a schematic of the control panel for remotely controlling the components and process flow in an embodiment of the HOCl manufacturing system and method 100. In some implementations the HOCl manufacturing system and method 100 performs the following operations.

In one or more embodiments, the HOCl manufacturing system and method 100 employs pressurized potable water (e.g., from municipal water services or otherwise pumped from available water supplies) that is filtered for partial dissolved solids at a particle filter 1010, treated to neutralize or remove pathogens at an organism filter 1020, and de-ionized to remove insoluble metals at an de-ionization unit 1030. In other embodiments, the supply water is known to be within acceptable parameters so these operations are not necessary. Subsequent to any needed filtering and de-ionization, the treated water flow is delivered to supply tank 1040 via a float valve 1050. In another aspect of some embodiments, water is also supplied to a brine tank 1060 via float valve 1070.

Continuing, in the HOCl manufacturing system and method 100, water from supply tank 1040 is delivered via pump 1080 (or other actuator) using feedback controlled pressure to an anolyte metering valve 1090 and a catholyte metering valve 1100. Specifically, the feedback controlled pressure is used to control the flow rate of the water into electrolysis chamber 1110 via an anode chamber inlet 1120 and a cathode chamber inlet 1130 of the electrolysis chamber 1110.

In some embodiments of the HOCl manufacturing system and method 100, electrical current is applied to electrolysis chamber 1110 and remotely controlled via a feedback controlled high-current power supply 1140 during the flow of water into the electrolysis chamber 1110. The electrical current applied by the feedback controlled high-current power supply 1140 is adjustable. In some embodiments, the current density is remotely controlled in a range of 1,000 to 5,000 Amperes/square meter. The current density range is a function of the conversion appropriate for the specifications of desired outcome product, e.g. agriculture products utilize approximately 35 ppm and lower current density range, while prion and COVID-19 virus disinfection utilizes approximately 300 ppm and higher current density range.

At this stage, sodium chloride (NaCl) brine is added and remotely controlled, via feedback controlled pump 1150 (or other actuator), to the anode chamber inlet 1120, which creates an aqueous mixture. In some embodiments, the NaCI brine that is input into the chamber is in a salinity range of between 500 and 30,000 parts per million (as needed and directed by characteristics of the product specifications dynamically at the time of production). The NaCl Brine input range is remotely controlled at a level that is appropriate for the specifications of the desired outcome product (e.g. 500 ppm equates to a no salt disinfectant, 20,000 ppm equates to an isotonic spray, and 30,000 ppm equates to ocean water inputs).

In some embodiments of the HOCl manufacturing system and method 100, the sodium hydroxide (NaOH) is added to the anode chamber inlet 1120 from the cathode chamber outlet 1170 and remotely controlled via a de-gassing chamber 1180 and a feedback controlled pump 1190 (or other actuator). In some embodiments, the NaOH that is input into the chamber is in a range of 100 to 500 parts per million (ppm). The NaOH input range is remotely controlled as is appropriate for the specifications of the desired pH outcome (e.g., 100 ppm equating to pH of 6.0, 200 ppm equating to a pH of 5.3 pH, 360 ppm equating to a pH of 4.2 pH, 400 ppm equating to a pH of 4.0 pH, and 500 ppm equating to a pH of 3.5 pH with an input water pH of 7.4 ). In other embodiments of the HOCl manufacturing system and method 100, the sodium hydroxide is supplied from an aqueous solution independent of the electrolysis mechanism with a feedback control system.

By applying the feedback-controlled electrical current in one or more embodiments of the HOCl manufacturing system and method 100, aqueous hypochlorous acid is produced at the anode chamber outlet 1160. Additionally, aqueous sodium hydroxide solution is produced at the cathode chamber outlet 1170. Specifically, the aqueous hypochlorous acid is directed to an anolyte buffer tank 1200 and the aqueous sodium hydroxide solution is directed to a catholyte buffer tank 1210. In one or more embodiments, the aqueous hypochlorous acid in the anolyte buffer tank 1200 may be pumped on demand to an external holding tank by pump 1230, and the sodium hydroxide solution in the catholyte buffer tank 1210 may be pumped on demand to an external holding tank by pump 1240.

Notably, in some embodiments of the HOCl manufacturing system and method 100, pH values from the input water in the supply tank 1040 are measured, determined, or otherwise obtained. Otherwise stated, it is determined if the input water is neutral, acidic, or alkaline. In one or more embodiments, these pH values from the input water are used in conjunction with the NaOH input levels (i.e., the ppm of the NaOH) to control the pH values of the HOCl solution that is output from the system. Accordingly, in some embodiments of the HOCl manufacturing system and method 100, the pH value of the water is adjusted to modulate the pH level of the target end product HOCl. For example, in one or more embodiments of the HOCl manufacturing system and method 100, the pH of the input water is increased prior to it being input into the electrolysis chamber. In some embodiments, this technique may be used to counter the non-linear reduction in pH that occurs during the electrolysis process.

During normal operation of this unadulterated HOCl producing electrolysis by the HOCl manufacturing system and method 100, specific gasses are expressed at the outlets of the electrolysis chamber 1110. Namely, hydrogen is expressed at the cathode chamber outlet 1170, and a chlorine and oxygen gas mixture is expressed at the anode chamber outlet 1160. The hydrogen gas is mixed to approximately 1000:1 air to hydrogen mixture. Accordingly, this mixture may be safely vented to the atmosphere outside any enclosed space or building. However, the chlorine and oxygen gas mixture is, in one embodiment, exchanged in a closed system that includes activated carbon block absorption filters 1125. These activated carbon block absorption filters 1125 are monitored by a chlorine sensor and are changed periodically as needed. In another embodiment, the chlorine gas is introduced to the catholyte water; in another, the chlorine gas is neutralized in the presence of acetic acid (e.g., vitamin C). In still another embodiment, the chlorine gas is disassociated in the supply water.

In some embodiments of the HOCl manufacturing system and method 100, product purity and quality are assured through continuous remote monitoring and error correction of system parameters. For example, electrochemical parameters that are measured and controlled include, by way of example only, and not by way of limitation, pH, oxidative reduction potential (ORP), free chlorine concentration, conductivity, and process temperature, are continuously measured by appropriate sensors 1260. In other aspect of the HOCl manufacturing system and method 100, still further parameters that are measured and controlled include, by way of example only, and not by way of limitation: anolyte flow rate, catholyte flow rate, supply water pressure, anolyte output pressure, catholyte output pressure, intrusion and tampering, and venting and gas presence.

The multiple variables that inform quality control include, by way of example only, and not by way of limitation: temperature, water quality, production output characteristics, chemical inputs of salt and hydroxide, pH inputs and outputs, electrical power quality, chlorine gas and hydrogen emission measurement and control. In some embodiments of the HOCl manufacturing system and method 100, water quality is controlled through minimal set points on hardness through Total Dissolved Solids (TDS) measurements that cause a shutoff at >1 ppm of calcium or magnesium. In another aspect of some embodiments, batch variability is measured (dynamically and over time) for system production variable errors to inform quality characteristics and optimal operating conditions that indicate proper immediate, ongoing, and scheduled maintenance needs.

In still another aspect of some embodiments, chemical inputs of salt and hydroxide are dynamically and remotely controlled by the HOCl manufacturing system and method 100 in accordance with the specifications of the desired output product (i.e., as determined by intended use of the product specifications). In this manner, for example, product specifications for sanitizer will be different than for wound healing. In yet another aspect of some embodiments, pH inputs and outputs that are dynamically and remotely controlled by the HOCl manufacturing system and method 100 in accordance with the specifications of the desired output product (i.e., as determined by intended use of the product specifications). In this regard, the pH of the water input will affect the pH of the product that is output. As described above, product specifications for sanitizer will be different than for wound healing.

In some embodiments, the HOCl manufacturing system and method 100 controls parameters that include, by way of example only, and not by way of limitation: salinity, chamber flow rate, chamber current and voltage, and pH. In such embodiments, these parameters may be controlled by dynamic adjustment of feedback control loop gain in each case. Some parameters are dynamically determined by product specifications that vary with respect to the parameters of the particular product applications (e.g., eye care, crop anti-fungal, medical disinfection, wound healing, and the like). Such parameters include, by way of example only, and not by way of limitation: product pH, product Free Available Chlorine (FAC), intracellular pressure, flow rate of anolyte, flow rate of catholyte, operating temperature, oxidation reduction potential (ORP), brine concentration and pH, chamber current and voltage, and product conductivity.

In one or more embodiments of the HOCl manufacturing system and method 100, harmonic distortion, noise, and voltage variability can impact the operation of the electrolysis chamber with potential detriment to the quality of the HOCl produced. Accordingly, in such embodiments of the HOCl manufacturing system and method 100, the power inputs are continuously monitored and correlated with system loop errors to inform any such negative effects therefrom. In some embodiments, data from the monitoring and system loop errors may be used to activate a power factor correction to circuitry to mediate such effects. In one or more embodiment, data from the monitoring and system loop errors may be used to activate a system shutdown in an extreme situation.

Notably, in some embodiments of the HOCl manufacturing system and method 100, the system monitors pH and Free Available Chlorine (FAC). The FAC may be measured amperometrically, spectrographically, or both. This measurement confirms that the FAC measured is chlorine in the HOCl form and not in the Cl₂ or OCl form, thereby ensure safety of manufacturing and product quality.

In some embodiments of the HOCl manufacturing system and method 100, the dynamically determined range of pH is between 3.5 and 6.0. In some more preferred embodiments of the HOCl manufacturing system and method 100, the dynamically determined range of pH is between 4.0 and 5.3. In some most preferred embodiments of the HOCl manufacturing system and method 100, the dynamically determined range of pH is between 4.0-4.2.

In another aspect of some embodiments of the HOCl manufacturing system and method 100, the dynamically determined range of ORP is between 850 and 1200. In some preferred embodiments of the HOCl manufacturing system and method 100, the dynamically determined range of ORP is 1000-1100.

In still another aspect of some embodiments of the HOCl manufacturing system and method 100, the dynamically determined range of free chlorine concentration is between 25 and 2000. In some preferred embodiments of the HOCl manufacturing system and method 100, the dynamically determined range of free chlorine concentration is between 100 and 500. In some embodiments of the HOCl manufacturing system and method 100, the dynamically determined range of salinity is between 0.01% and 2%.

In yet another aspect of some embodiments of the HOCl manufacturing system and method 100, the acceptable range of process temperature is between 8° C. and 24° C. Accordingly, in one or more embodiments, HOCl manufacturing system and method 100, monitors the temperature outside the unit to assist with maintaining the proper operating temperature. Additionally or alternatively, in some embodiments the HOCl manufacturing system and method 100 compensates for temperature changes by using adjustments of current, NaCl, NaOH and velocity inputs.

Additionally, in some embodiments of the HOCl manufacturing system and method 100, the electrolysis chamber is fed with a pH-controlled and identified premixed brine with parameters of pH of 11-12.5 and salinity of 700 micro Siemens (μS) to 20 mS.

In some embodiments of the HOCl manufacturing system and method 100, the main control loops that are active during normal operation include, by way of example only, and not by way of limitation: NaOH injection, electric current, saline concentration, and flow rate. In one or more embodiments, a set pH is maintained by automatically varying the amount of sodium hydroxide added to the anolyte chamber 1120 inlet via an injection pump 1190 (or other actuator). Additionally, in one or more embodiments, a free chlorine concentration set-point is maintained by varying the amount of each of electric current, saline concentration, and flow rate, both independently and concurrently.

In some embodiments of the HOCl manufacturing system and method 100, the process control center monitors and controls multiple feedback loops. For example, in one or more embodiments, the process control center controls of the brine input variable that affects parts per million (ppm) of the active ingredient. Additionally, in one or more embodiments, the process control center controls the target pH using a catholyte control loop. Furthermore, in one or more embodiments, the process control center controls flow rate, which fine tunes the volume and pH value. All of these feedback control loops provide upper and lower limits using qualitative controls of both dynamic inline readouts and sampled averages. In this manner, parameter limits may be dynamically set remotely and monitored through the feedback loops for quality affected by factors such as local water, power, and input variables. These parameter limits may provide for local and remote feedback such as “Acceptable”, “Warning”, and “Failure/Stop” modes that are communicated through the remote communications system. This communications system may send messages to either or both of a local operator and the basecamp remote home factory.

Accordingly, in such embodiments, the HOCl manufacturing system and method 100 employs process controls that manage these parameters through remote monitoring and feedback loop systems. These feedback loop systems provide a quality control consistency of manufacture that may be adjusted to meet whatever product specifications are desired.

As described herein, the authentic, unadulterated pure aqueous hypochlorous acid produced by the HOCl manufacturing system and method 100 is defined as a free chlorine concentration solution of hypochlorous acid that does not contain stabilizing buffers and does not contain detectable hypochlorite, and in which the pH is measured in the spectrum that completes its chemical reaction and at a spectrographic range of 720-740 centimeters⁻¹ with a pH that maximizes its ORP.

Any amount of hypochlorite that exists in a less than authentic, unadulterated impure HOCl solution (known scientifically as “mixed oxidant”), creates a condition of reactivity that drives the mixed oxidant HOCl solution into a degrading chemical reaction which eventually leads to a full hypochlorite state. This degrading chemical reaction in a mixed oxidant HOCl solution has been typically been contained in prior systems through use of stabilizing buffers. For this reason, mixed oxidant HOCl solution can be identified as such (i.e., a less than authentic, unadulterated pure HOCl solution), even if they claim to be “pure,” by their inclusion of stabilizing buffers, hypochlorite, or both. Even a very small amount of either stabilizing buffers, hypochlorite, or both renders any such solution as a mixed oxidant, and not an authentic, unadulterated pure aqueous hypochlorous acid. Furthermore, the addition of stabilizing buffers adulterates any solution into an impure state by definition.

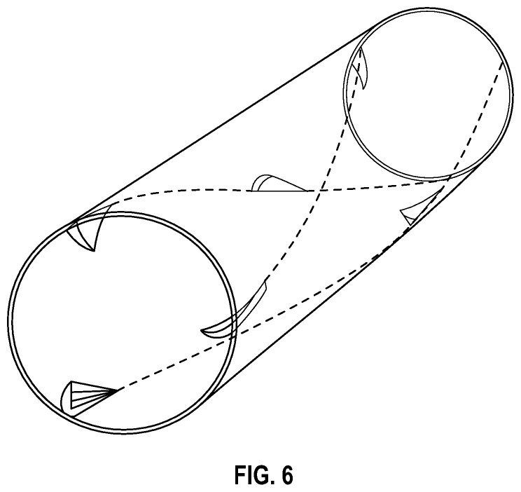

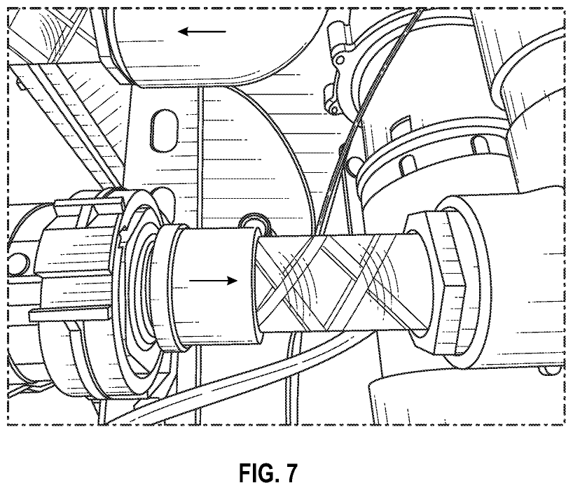

Referring now to FIGS. 6 and 7, in one or more other embodiments, the HOCl manufacturing system and method 100 utilizes a biochemistry synthesis process. In some embodiments, the inputs and outputs of the HOCl manufacturing system and method 100 are part of a laminar cross-flow electrolysis chamber. The electrolysis chamber is fed with a pH-controlled and quantified premixed brine. The electrolysis chamber utilizes Schauberger-type dynamic vortex implosion inputs that are injected into a laminar flow plenum. This technique rotates water inline so as to drive energy into the water structure (i.e., implosion through creation of a DNA-type folding spiral flow). Each laminar flow plenum is preferentially platinum encased. In some embodiments, laminar flow plenum is more preferentially alternating platinum and ruthenium-iridium oxide encased. Notably, higher ppm values (e.g. 500-2000 ppm) are attained as a result of using a sandwich of platinum cathodes and ruthenium-iridium anodes (i.e., positioning platinum cathodes and ruthenium-iridium anodes between each other). Otherwise stated, higher ppm values of pure HOCl as Free Available Chlorine as high as 2000 ppm are achieved through the conversion of reactive oxidant species flowing between plenums of platinum surfaced cathodes and ruthinium-iridium oxide coated anodes. In another aspect of some embodiments, the laminar flow plenum is bifurcated with hydrogen-permeable membranes, such as a Nafion™ (sulfonated tetrafluoroethylene based fluoropolymer-copolymer) membrane.

In some embodiments, the anolyte (i.e., aqueous hypochlorous acid) and the catholyte (i.e., aqueous sodium hydroxide solution) are produced in tandem flows in a controllable condition of non-reciprocity of flow. In another aspect, the anolyte hypochlorous acid is free from hypochlorites, phosphates, oxides, and stabilizers and exhibits thermal resistant stability. Furthermore, the aqueous hypochlorous acid possesses an ORP state of greater than 1000. In still further embodiments, the aqueous hypochlorous acid possesses an ORP state of preferentially greater than 1100. Notably, stable ORP is a significant component of HOCl viability in the HOCl manufacturing system and method 100.

In another aspect of some embodiments, the HOCl manufacturing system and method 100 exhibits control of flow turbulence dynamics through management of pipe size and gating. This control imparts downstream consistency and manages the effect of the electrolysis result beyond pressure input management, pressure measurement and flow. The chamber discloses using backflow pressure control, gating, and feedback at anolyte and catholyte exit ports, such that the exiting laminar flows of both anolyte and catholyte are restricted in a manner that interrupts flow and creates backpressure inside the vessel. The backpressure interrupts the traditional efficacy of the transformation of hydrogen and oxygen splitting in electrolysis and maximizes reconfiguration of hydrogen bonding reformation in anolyte production through creation of eddy whorls at the edges of laminar flow in platinum encased plenums through extended exposure to ‘time in chamber’ effect. This action maximizes non-linear flow of laminar flow through backpressure-controlled exit gating.

Additionally, flow modeling shows that this process creates chaotic eddy formation within the brine input and electrochemical transactions in known points of the chamber. Through co-located external introduction to these points of non-linear flow on the anolyte side of the electrolysis chamber, the HOCl manufacturing system and method 100 optionally positions one or more of permanent magnets such that their positive magnetic field lines intersect through a non-magnetic outer housing with the maximum electrochemical eddy whorl stream internal to the non-linear anolyte flow.

Using this method, a hydrogen lattice may be developed by the positive magnetic field presentation to an electrochemical process in a defined eddy whorl flow of a laminar flow platinum saltwater electrolysis process. The resulting HOCl produced is a free chlorine concentration solution of hypochlorous acid that does not contain stabilizing buffers and does not contain detectable hypochlorite, and in which the pH is measured in the spectrum that completes its chemical reaction at a spectrographic range of 720-740 centimeters⁻¹ with a pH that maximizes its ORP, as shown in FIG. 1. Additionally, the resulting HOCl is imbedded in a carrier of electrolyzed water, preferentially isotonic, but optionally 0.01%-2% salt, and a condition of maximized oxidative reduction potential (ORP) preferentially 1000-1100.

Raman scattering is a spectroscopic technique that provides information about molecular vibrations and may be used for sample identification and quantitation. Raman spectroscopy involves shining a monochromatic light source (i.e., laser) on a sample and detecting the scattered light. The majority of the scattered light is of the same frequency as the excitation source. However, a very small amount of the scattered light is shifted in energy from the laser frequency due to interactions between the incident electromagnetic waves and the vibrational energy levels of the molecules in the sample. Plotting the intensity of this “shifted” light versus frequency results in a Raman spectrum of the sample. The Raman spectrum can be interpreted in a manner similar to the interpretation of an infrared (IR) absorption spectrum.

In some embodiments, the HOCl manufacturing system and method 100 is a deployable, modular, high-production pure hypochlorous acid (HOCl) manufacturing system. The HOCl manufacturing system and method 100 produces pure, stable, authentic HOCl. The HOCl manufacturing system and method 100 is designed for deployment and on-site production of HOCl at a remote location by remote monitoring and control. Significantly, the HOCl manufacturing system and method 100 produces pure, stable, authentic HOCl using only electrolyzed water, HOCl and table salt. The pure, stable, authentic HOCl produced by the HOCl manufacturing system and method 100 contains 0% detectable bleach, %0 detectable chlorates, and 0% detectable alcohol, using detection methodologies as described herein and known in the art. Additionally, the pure, authentic HOCl produced by the HOCl manufacturing system and method 100 is stable at room temperature, freezing temperatures (i.e., −80° C.), and high temperatures (i.e., 80° C.). As defined herein, stable means that the HOCl composition described herein within an unopened container, has a detectable loss of ORP after 36 months of storage at 25° C. that is less than 10%, preferably less than 5%, and more preferably 0%. Additionally, as defined herein, stable means that the HOCl composition described herein within an unopened container, has a detectable loss of HOCl after 36 months of storage at 25° C. that is less than 50% and still more preferably less than 25%. Furthermore, as defined herein, stable means that the HOCl composition described herein within an unopened container, has no measureable hypochlorites or oxidants after 36 months of storage at 25° C.

Notably, small changes in pH have exponential effects on the composition of any HOCl. Additionally, any errors in the HOCl manufacturing process create chlorine, chlorite, hypochlorite, or perchlorate—each of which are toxic or caustic. Due to these instability problems that have previously been unsolvable in the creation of HOCl-containing preparations (which actually comprise mixed oxidant/HOCl hybrid solutions), the previously described versions of such mixed oxidant HOCl solutions were unstable and degraded within about 72 hours. Significantly, the pure, authentic HOCl produced according to the present disclosure is stable, and is capable of lasting for years on a shelf at temperatures ranging from below zero to +170° F. without detectable degradation and without appearance of detectable contaminating bleach, chlorates or alcohol, in contrast to previous versions of mixed oxidant HOCl solutions that lasted merely hours or days.

### Remote Monitoring and Control

In some embodiments, the HOCl manufacturing system and method 100 includes one or more deployed units and a basecamp unit. The deployed units have been described above. The basecamp unit is the home central command unit at which authorized operators monitor and control the functions of the components in the deployed units. The authorized operators at the basecamp unit may remotely monitor and adjust the parameters of actuators and other components in the one or more deployed units to control the product quality, as well as change the product that is being produced (e.g., HOCl as specifications for eye care, HOCl as specifications for instrument sterilization, HOCl as specifications for wound healing, and the like).

The authorized operators at the basecamp unit may remotely activate or shutdown the functions of the one or more deployed units for security or quality proposes. In some embodiments of the HOCl manufacturing system and method 100, remote shut down of a deployed unit is activated by the basecamp unit in the response to control quality issues or dangerous conditions. In one or more embodiments of the HOCl manufacturing system and method 100, the equipment shut down is performed through a software lock that is performed automatically and remotely in the case of quality issues, dangerous conditions, or security breaches (e.g., tampering, opening of doors while running, and the like). In some embodiments of the HOCl manufacturing system and method 100, only the basecamp unit may activate a reset condition for use of the deployed unit after this type of shutdown.

In another aspect of some embodiments, the HOCl manufacturing system and method 100 assures quality of the pure, unadulterated HOCl produced through remote monitoring of real-time diagnostics utilizing Ethernet, GSM or Satellite uplink technologies. Such features include: remote real time review and adjustments through process control and alarms; remote real time modifications of product attributes for optimized applications in the field; remote oversight in adherence to pharmaceutical cGMP, EPA, and ISO standards; remote volumetric monitoring for preventative maintenance cycles; remote monitoring of the volume of HOCl produced; and remote shut down in the case of quality issues or dangerous conditions.

In one or more embodiments, the components of each deployed unit in the HOCl manufacturing system and method 100 are dynamically and remotely monitored at a disparate basecamp unit by authorized operators. The variable inputs are dynamically determined and monitored as concurrent outputs within the statistical process control (SPC) range allowed in their variabilities as determined by the product specifications (e.g., eye care product pH range of 4.0-4.2; Salinity of 1.0-0.85, and the like).

In some embodiments, the HOCl manufacturing system and method 100 includes remote diagnostics feedback using a system of dynamic overview. Optionally, in areas of spotty connectivity, temporary memory storage and data download dumps may be used to enable analysis of product volumes and product variances. The analysis of product volumes and product variances may produce feedback events or alerts, such as LOW, HIGH, WARNING, OUT OF SPEC, TAMPER, and SHUT DOWN conditions. In one or more embodiments, the HOCl manufacturing system and method 100 enables pH and ORP parameters to be controlled through feedback loops in dynamically specified upper and lower limit settings. These dynamically specified upper and lower limit settings are adjustable to match different product types (e.g., products with different HOCl concentration levels). The upper and lower limit settings cause “WARNING” or “FAILURE” notification to assure quality standards. In some embodiments, such notifications also result in automatic shutdown of all of the system or just in the specific area of the system that triggers the warning, as appropriate.

### Security Features

In some embodiments of the HOCl manufacturing system and method 100, the quality of the produced HOCl and the security of the system are managed through multiple layers of security. These security measures prevent the tampering, resetting, misalignment, unauthorized copy, misuse, or damage of the system. For example, multiple inputs within the system are disguised so that they are not obvious to third parties without access permissions. In another aspect of HOCl manufacturing system and method 100, the feedback control systems described above are able to be used for both quality control and security.

From a physical standpoint, the HOCl manufacturing system and method 100 has hardened high-security features incorporated into its portable enclosure for remote placement in harsh environments. In one or more embodiments, the HOCl manufacturing system and method 100 is encased in a refrigerated cabinet (as used for hospital placement or other modular configurations) that includes shipping containers with a thick metal exterior and locking systems to encompass its contained technologies after deployment.

From a cybersecurity standpoint, the HOCl manufacturing system and method 100 provides for assurance of quality production on-site after the system has been deployed by preventing tampering with the remote control of the HOCl production controls and parameters. The HOCl manufacturing system and method 100 includes multiple levels of security protections to ensure non-tampering, non-circumvention, and monitored quality control during remote production of pure, authentic HOCl after the HOCl manufacturing system and method 100 has been remotely deployed. Specifically, cybersecurity features implemented by the HOCl manufacturing system and method 100 may include, by way of example only, and not by way of limitation: disabling vulnerable ports and services, removing vulnerable features of the operating system, uninstalling vulnerable software, removing vulnerable applications, evolving security features frequently, and the like.

In another security aspect, some embodiments of the HOCl manufacturing system and method 100 include security triggers that detect and indicate any tampering, reverse engineering, or movement of the HOCl manufacturing system and method using feedback monitoring. In response to any such detected tampering, reverse engineering, or movement of the deployed system, the HOCl manufacturing system and method 100 is configured to initiate remote disablement of all or part of the system, as appropriate. In some embodiments, the HOCl manufacturing system and method 100 is configured to automatically initiate remote disablement in response to detecting activation of a security trigger related to tampering, reverse engineering, or movement of the unit. In other embodiments, the HOCl manufacturing system and method 100 is configured to alert authorized personnel at another location of the security breach, and enable the authorized personnel at the other location to initiate remote disablement in response to detecting activation of a security trigger related to tampering, reverse engineering, or movement of the unit.

Regarding the detection of movement of the unit, in some embodiments, the HOCl manufacturing system and method 100 includes GPS geo-location positioning switches that enable the system to incorporate an “authorized to work” setting at a specified location (e.g., which may be designated by Latitude and Longitude locations). In such an embodiment, the HOCl manufacturing system and method 100 is only functional when the “authorized to work” setting is activated. Additionally, in some such embodiments of the HOCl manufacturing system and method 100, this “authorized to work” setting will force a shutdown of the system if the deployed HOCl manufacturing system and method 100 is moved more than a specify distance (e.g., 10 meters) from an agreed upon location without authorization. Accordingly, the entire deployed HOCl manufacturing system and method 100 may be disabled if it is physically stolen or moved without authorization, thus offering oversight management of the HOCl Manufacturing System 100.

In one or more embodiments, the HOCl manufacturing system and method 100 includes a shutdown timer system for security authorization. In some embodiments, the shutdown timer system includes a “minutes of use” feature that is automatically reset on intervals of connectivity through the remote diagnostic program. Alternatively, in areas where the HOCl manufacturing system and method 100 is placed at a remote location “off the grid,” a reset of the shutdown timer system may be accomplished using a regularly electronically delivered reset key or physical dongle.

In still another security aspect, the HOCl manufacturing system and method 100 includes Virtual Private Network (VPN) technology that is certified in handling credit cards. In yet another security aspect, the HOCl manufacturing system and method 100 includes Payment Card Industry (PCI) technology to protect data during transmission. These cybersecurity protections enable the HOCl manufacturing system and method 100 to leverage the Wi-Fi of a local airport, localized facilities, and other local technologies to ensure the system is secure from a cyber-perspective.

In yet another security aspect, the HOCl manufacturing system and method 100 includes hidden proximity switches that control the flow of the pure, unadulterated HOCl and its components, as well as preventing the analysis of flow components by incorporating hidden valves that are triggered by the hidden proximity switches. Accordingly, these hidden valves that are triggered by the hidden proximity switches discourage unauthorized personnel from removing components of the HOCl manufacturing system and method 100 in an attempt to analyze its components.

Referring now to another security feature of the HOCl manufacturing system and method 100, in some embodiments the system incorporates overmolding material which encapsulates and protects electronic components. Overmolding material may be implemented to prevent the visual review of boards, components, and chamber design by unauthorized personnel or third parties. While overmolding material is useful to prevent visual review of boards, components, and chamber design by unauthorized personnel or third parties, X-ray examination (or other penetrating imaging) is also a potential security concern. In this regard, in some embodiments the HOCl manufacturing system and method 100 incorporates anti-x-ray (e.g., x-ray scatter, x-ray shielding, carbon-impregnated, etc.) paint. Such anti-x-ray paint is incorporated to prevent any penetrative review of critical internal components and chamber design using x-ray, Magnetic Resonance Imaging (MRI), of other penetrative imaging technique. In other embodiments, other anti-penetrative imaging paint may be used that is configured to block wavelengths other than or in addition to x-rays. In still other embodiments, anti-penetrative imaging materials are used other than paint to block penetrative imaging, whether it be at x-ray wavelengths or other wavelengths.

Referring still to the overmolding feature of the HOCl manufacturing system and method 100, in some embodiments the system incorporates reactive capsules that are placed randomly into the overmolding material. Thus, if there is any tampering with the overmolding material in an attempt to circumvent or remove the overmolding material, this will cause the reactive capsules to rupture and release a highly reactive acid or other substance onto the internal components (e.g., boards, components, and chamber design). The release of this highly reactive acid or other substance from the reactive capsules results in the liquefaction (or other destruction) of the internal components as a result of unauthorized individuals forcing an unauthorized opening of the overmolding material. In this manner, the reactive capsules may be sealed and contained within solid components that are designated as “no access” components. Accordingly, unauthorized and forced opening or cutting of such “no access” component housings results in the destruction of critical internal components. This security feature prevents the physical theft and analysis of critical internal components that are protected in this manner.

In yet another aspect, the HOCl manufacturing system and method 100 incorporates a chemical marker feedback loop monitoring system in some embodiments. In some embodiments, a chemical marker is introduced into a component of the aqueous solution flow as part of a chemical marker identification system. This chemical marker may be detected downstream in a process or sales flow for one or more of the following objectives: (1) an indicator of the correctness of the components used in an operation, (2) the detection of improper components being used as inputs, and (3) deviations from the components that should be present in the manufacturing process. Otherwise stated, the chemical marker may be used as a source identifier to confirm that proper input components are being used in a manufacturing process and that there are no deviations from the specifications either intentionally (e.g., swapping out components for cheaper but inferior substitutes) or unintentionally (e.g., mistakenly uses the wrong components).

In some embodiments of this chemical marker identification system, the marker may be an identifiable chemical that is added to flow either pre-electrolysis or post-electrolysis. This chemical marker is present in a low and process-defined concentration that is unaffected by the electrochemistry of the HOCl product. Notably, many substance do effect the electrochemistry of the HOCl product so it is significant to only use a chemical marker that does not cause the decay of the HOCl product, for example, decay into mixed hybrid solutions containing hypochlorites and/or oxidants. The chemical marker selected does not affect the electrochemistry of the HOCl, even after years of storage. Additionally, the chemical marker selected must be safe for all the applications that the product will be used for such as wound care, eye care, food product disinfectant, and the like. Furthermore, the chemical marker must be detectable by an appropriately sensitive monitoring device. Accordingly, a chemical signature is embedded in the product that enables for the products later identification as to confirmation of source when the product is subjected to appropriately sensitive analytical procedures.

As described above, the presence of this chemical marker is useful for purposes including, by way of example only, and not by way of limitation:

detecting volume deviations, detecting flow deviations, detecting adulteration of components, detecting accidental misuse wrong component, and the like. In some embodiments, a monitoring analysis technique may be used to detect particular emission characteristics of the chemical marker, which may include, by way of example only, and not by way of limitation: spectrophotometric analysis, colorimetric analysis, spectroscopy, ion chromatography, flame photometry, or fluorometry. Thus, the presence of such chemical markers is useful for not only for production monitoring purposes but can serve as “fingerprints” that demonstrate source confirmation by in-line or spectrophotometric analysis, colorimetric analysis, mass spectroscopy, liquid or ion chromatography, flame photometry, or fluorometry, amongst other procedures.

In one or more embodiments, these one or more of these techniques serve as the most appropriate detection system. Using an additive chemical marker in this manner creates a nonobvious component source confirmation system that is not readily detectable by the uninformed operator. Furthermore, the chemical marker identification system may be used to collect information about the HOCl manufacturing system's operation at a distance. In this manner, the chemical marker identification system provides quality assurance, traceability, and source information. In some embodiments, this chemical marker is checked by distributed manufacturing partners throughout the globe to identify, inclusively or exclusively, a product in the market as being authentic, counterfeit, or adulterated.

The chemical marker identification system may also be used in conjunction with block-chain validation by providing a source information. This source information may then be incorporating into a block chain tracking system to provide providence and supply chain tracing. A block chain is a distributed, digital ledger. The ledger records transactions in a series of blocks. It exists in multiple copies spread over multiple computers, typically known as nodes. Distributed ledger systems (i.e., block chains) may be used in conjunction with the chemical marker identification system to record product status at each various stages of manufacture, sale, and transport.

In one or more embodiments of the chemical marker identification system, the chemical marker is selected from a group that includes certain organic heterocyclic compounds in the imidazolidinone/oxazolidinone/hydantoin family, for example 2,2,5,5-tetramethylimidazolidin-4-one, or certain short chain carboxylic organic acids such as butyric acid, or water soluble compounds containing rare earth metal elements such as neodymium or lanthanum. Such chemical markers are non-reactive, temperature stable, and identifiable in downstream lots for source identification and authenticity. In some such embodiments, the chemical marker is added to the flow pre-electrolysis or post-electrolysis and is present in a low and process-defined concentration. In other embodiments, one or more different chemical markers are utilized in other of the components so that multiple components in the same manufacturing process may be tracked and/or have their sources confirmed.

In another embodiment of the chemical marker identification system, the chemical marker is the composition (2,2,5,5-tetramethylimidazolidin-4-one). This composition maybe added up front to the water or salt and end up detectable in all HOCl at, for example, 1 parts per billion (ppb) −10 parts per million (ppm). At this level the composition will not affect the HOCl stability. HOCl produced by the disclosed system and method is stable in water for years, inert, not toxic to vertebrates or invertebrates, in addition to being stable at boiling, freezing, and room temperature. Notably, in some embodiments of the chemical marker identification system, the chemical marker is added post production as a marker that serves to authenticate source of origin of the product in the marketplace.

### Machine Learning And Artificial Neural Networks:

As stated above, the HOCl manufacturing system and method 100 is a Chlor-Alkali electrolysis mechanism utilizing a self-regulating system that balances source water pH, electrolysis cell current, anolyte and catholyte fluid flow, closed loop brine injection, product pH, ORP, and Free Available Chlorine to tightly control all parameters of the various HOCl solutions manufactured by the system 100.

In some embodiments of the HOCl manufacturing system and method 100, all parameters (e.g., input components, control loop parameters, and the like) of the system have multiple effects on the output product (i.e., pure, stable, authentic HOCl). For example only, and not by way of limitation, increasing the electric current in the electrolysis cell increases the free available chlorine, but also lowers the product pH, requiring an adjustment to the supply water pH to maintain acceptable production levels of the stable, authentic HOCl output product. Therefore, single parameter control loops, even when linked in industry standard fashion, are ineffective in controlling a HOCl manufacturing system and method 100 through long periods of operation. Thus, in some embodiments of the HOCl manufacturing system and method 100 that do not incorporate machine learning and artificial neural networks, oversight by trained technicians is employed to monitor for process deviations beyond the ability of the system to respond to and self-correct.

In other embodiments of the HOCl manufacturing system and method 100, the closed loop control systems are replaced with a combination of machine learning and artificial neural networks to control the process of producing the pure, stable, authentic HOCl. In such embodiments, the multiple linked Proportional Integral Derivative (PID) loops used to control the WHISH chlor-alkali process are replaced by a combination of artificial neural networks (ANN) and machine learning (ML) models that enable significantly tight control of the HOCl end product and eliminate oversight by operators of the HOCl manufacturing system and method 100.

In some implementations, controls that were previously performed by remote technicians in other embodiments are replaced with a combination of ML algorithms and real-time closed loop adaptive learning control, such as particle swarm optimization. In particular, the nonlinear pH control loops are subject to ANN and/or ML control, by predicting future behavior of the pH adjustment parameters and performing the real-time control of the pH adjustment loops, electrolysis current, brine, and other parameters with real-time particle swarm optimization or similar machine control algorithms. This real-time control adjusts each closed loop control in relation to other closed loop controls, monitoring the multiple, linked effects of each control parameter in real time to find a constantly adapting solution to the complex chemical process.

In still other aspects of some embodiments, a set of machine learning models based on historic production data from a particular machine are used to influence the artificial neural networks or real time machine learning models. Such machine learning models control each of the closed loop cycles that define the WHISH process and enable the machine to self-correct as the chlor-alkali generation process shifts over the course of a production run.

Brio-Ocean:

Alternatively to some processes described above, in other embodiments of the HOCl manufacturing system and method 100, there are no separate chemical inputs of salt and/or hydroxide to create the desired pure, stable, authentic HOCl; but rather raw untreated seawater (i.e., salt water without additional salts, buffers, agents or catalysts) is the only input component used to produce the pure, stable, authentic HOCl. In some such embodiments of the HOCl manufacturing system and method 100, the main control loops that are active during normal operation include electric current and flow rate. In some embodiments, electrical current is applied to electrolysis chamber 1110 and is remotely controlled via a feedback controlled high-current power supply 1140 during the flow of water into the electrolysis chamber 1110. The feedback controlled pressure is used to control the flow rate of the seawater into electrolysis chamber 1110 via an anode chamber inlet 1120 and a cathode chamber inlet 1130 of the electrolysis chamber 1110. The pure, stable, authentic HOCl produced by the HOCl manufacturing system and method 100 contains 0% detectable bleach, %0 detectable chlorates, and 0% detectable alcohol, using detection methodologies as described herein.

Temperature Stability:

Additionally, the pure, authentic HOCl produced by the HOCl manufacturing system and method 100 is stable at room temperature, freezing temperatures (i.e., −80° C.) and high temperatures (i.e., 80° C.). For example, the HOCl manufacturing system and method 100 produces pure, stable, authentic HOCl that can be frozen up to four times without detriment to its efficacy. This thermal stability feature of pure, stable, authentic HOCl produced by the HOCl manufacturing system and method 100 is enabled by the extremely unadulterated nature of the aqueous hypochlorous acid, which is free from any measureable amount of hypochlorites, phosphates, oxides, and stabilizers. Additionally, this pure, stable, authentic HOCl produced by the HOCl manufacturing system and method 100 has a detectable loss of ORP after being frozen up to four times that is less than 10%, preferably less than 5%, and more preferably 0%.

Such contaminates accelerate the deterioration of HOCl mixtures when they are frozen to the detriment of the efficacy of the HOCl mixtures. Otherwise stated, the presence of contaminates such as chlorine, chlorite, hypochlorite, and perchlorate (each of which are toxic or caustic), which may be created due to errors in inadequate HOCl mixture manufacturing processes, cause the original HOCl in the HOCl mixture to unravel into chlorine, chlorite, hypochlorites, and other substances when frozen (as well as simply over time). These contaminated HOCl mixtures not only have very poor efficacy, but also are often toxic or caustic. Thus, the ability of the HOCl manufacturing system and method 100 to produce pure, stable, authentic HOCl is a dramatic technological improvement since it enables the use of the pure, stable, authentic HOCl on human tissue, epithelials, membranes, and the like, without damaging the human tissue.

In another implementation, the HOCl manufacturing system and method 100 produces pure, stable, authentic HOCl that can be heated to as much as 100C while maintaining efficacy. Again, this thermal stability feature of pure, stable, authentic HOCl produced by the HOCl manufacturing system and method 100 is enabled by the extremely unadulterated nature of the aqueous hypochlorous acid, which is free from any measureable amount of hypochlorites, phosphates, oxides, and stabilizers. Additionally, this pure, stable, authentic HOCl produced by the HOCl manufacturing system and method 100 has a detectable loss of ORP after being heated to as much as 100C that is less than 10%, preferably less than 5%, and more preferably 0%.

Such contaminates accelerate the deterioration of HOCl mixtures when they are heated to the detriment of the efficacy of the HOCl mixtures. Otherwise stated, the presence of contaminates such as chlorine, chlorite, hypochlorite, and perchlorate (each of which are toxic or caustic), which may be created due to errors in inadequate HOCl mixture manufacturing processes, cause the original HOCl in the HOCl mixture to unravel into chlorine, chlorite, hypochlorites, and other substances when heated (as well as simply over time). These contaminated HOCl mixtures not only have very poor efficacy, but also are often toxic or caustic.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other portable and/or wearable electronic devices, not necessarily the exemplary wearable electronic devices generally described above.

For instance, the foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs executed by one or more computers (e.g., as one or more programs running on one or more computer systems), as one or more programs executed by one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various implementations described above can be combined to provide further implementations. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, are incorporated herein by reference, in their entirety. Such applications specifically include: The HOCl Molecule Solution: (1) No. 62/353,483 Inactivation Of Highly Resistant Infectious Microbes And Proteins With Hypohalous Acid Preparations; (2) International Patent Application No. PCT/US2017/038838: Aqueous Hypohalous Acid Preparations For The Inactivation Of Resistant Infectious Agents; and (3) International Patent Application No. PCT/US2019/036722.

Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. An electrolysis method using a deployable, remote-controlled manufacturing system, the method comprising:
in response to a remote activation, controlling water flow rate into an electrolysis chamber, by providing feedback controlled water pressure;
in response to the remote activation, applying feedback controlled current to the electrolysis chamber via an adjustable and high-current power supply;
in response to the remote activation, adding sodium chloride brine, via a feedback controlled actuator, to an anode chamber inlet and creating an aqueous mixture;
in response to the remote activation, adding sodium hydroxide, via the feedback controlled actuator, to the aqueous mixture; and
producing aqueous hypochlorous acid at an anode chamber outlet, and aqueous sodium hydroxide solution at a cathode chamber outlet, wherein the aqueous hypochlorous acid is free from hypochlorites, phosphates, oxides, and stabilizers.

2. The method of claim 1, wherein adding the sodium hydroxide to the aqueous mixture further comprises adding the sodium hydroxide to the anode chamber inlet from the cathode chamber outlet via a de-gassing chamber and pump.

3. The method of claim 1, wherein adding the sodium hydroxide to the aqueous mixture further comprises adding the sodium hydroxide from an aqueous solution independent of an electrolysis mechanism.

4. The method of claim 1, wherein the aqueous hypochlorous acid produced at the anode chamber outlet is directed to an anolyte buffer tank.

5. The method of claim 1, wherein the aqueous sodium hydroxide solution produced at the cathode chamber outlet is directed to a catholyte buffer tank.

6. The method of claim 1, wherein the aqueous hypochlorous acid is free from metal cations, periodate, phosphate buffers, carbonate buffers, and organic compounds with halogen stabilizing abilities.

7. The method of claim 1, wherein the method does not include titration.

8. The method of claim 1, wherein the method does not use any acid as an input component.

9. The method of claim 1, wherein the aqueous hypochlorous acid has a Raman spectroscopy value range of 720 centimeters' -740 centimeters'.

10. The method of claim 1, wherein a pH balance of the aqueous hypochlorous acid is controllable using one or more of the feedback controlled water pressure, a feedback controlled electric current, a feedback controlled sodium chloride, and a feedback controlled sodium hydroxide.

11. The method of claim 1, wherein parts per million (PPM) of HOCl in the aqueous hypochlorous acid is controllable using one or more of the feedback controlled water pressure, a feedback controlled electric current, a feedback controlled sodium chloride, and a feedback controlled sodium hydroxide.

12. The method of claim 1, wherein a salt concentration of the aqueous hypochlorous acid is controllable using one or more of the feedback controlled water pressure, a feedback controlled electric current, a feedback controlled sodium chloride, and a feedback controlled sodium hydroxide.

13. The method of claim 1, wherein an oxidative reduction potential (ORP) of the aqueous hypochlorous acid is controllable using one or more of the feedback controlled water pressure, a feedback controlled electric current, a feedback controlled sodium chloride, and a feedback controlled sodium hydroxide.

14. The method of claim 1, wherein an amount of free chlorine concentration in the aqueous hypochlorous acid is controllable using one or more of the feedback controlled water pressure, a feedback controlled electric current, a feedback controlled sodium chloride, and a feedback controlled sodium hydroxide.

15. The method of claim 1, wherein a hydrogen gas is expressed at the cathode chamber outlet of the electrolysis chamber, and a chlorine and oxygen gas mixture are expressed at the anode chamber outlet of the electrolysis chamber.

16. The method of claim 15, wherein the hydrogen gas is approximately 1000:1 air to hydrogen mixture, and safe to vent.

17. The method of claim 15, wherein the chlorine and oxygen gas mixture is exchanged in a closed system which includes activated carbon block adsorption filters.

18. The method of claim 17, wherein the activated carbon block adsorption filters are monitored by a chlorine sensor.

19. The method of claim 1, wherein water from a water supply has been filtered for partially dissolved solids.

20. The method of claim 1, wherein water from a water supply has been treated to neutralize or remove pathogens.

21. The method of claim 1, wherein water from a water supply has been de-ionized to remove insoluble metals.

22. The method of claim 1, further comprising:
obtaining a pH value from input water prior to the input water entering the electrolysis chamber;
adjusting the pH value of the input water prior to the input water entering the electrolysis chamber; and
modulating pH values of the aqueous hypochlorous acid that is produced by the system using the pH value adjustment of the input water in conjunction with adjustment of the sodium hydroxide input levels.

23. An electrolysis method using a deployable, remote-controlled, hypochlorous acid (HOCl) manufacturing system, the method comprising:
providing feedback controlled water pressure to an anolyte metering valve and a catholyte metering valve;
controlling water flow rate into an electrolysis chamber, via an anode chamber inlet and a cathode chamber inlet of the electrolysis chamber;
during water flow into the electrolysis chamber, applying current to the electrolysis chamber via an adjustable and feedback controlled high-current power supply;
adding sodium chloride brine, via a feedback controlled pump, to the anode chamber inlet and creating an aqueous mixture;
adding sodium hydroxide, via the feedback controlled pump, to the aqueous mixture; and
producing aqueous hypochlorous acid at an anode chamber outlet, and aqueous sodium hydroxide solution at a cathode chamber outlet, wherein the aqueous hypochlorous acid is free from hypochlorites, phosphates, oxides, and stabilizers.

24. The method of claim 23, wherein adding the sodium hydroxide to the aqueous mixture further comprises adding the sodium hydroxide to the anode chamber inlet from the cathode chamber outlet via a de-gassing chamber and a pump.

25. The method of claim 23, wherein adding the sodium hydroxide to the aqueous mixture further comprises adding the sodium hydroxide from an aqueous solution independent of an electrolysis mechanism.

26. The method of claim 23, wherein the aqueous hypochlorous acid produced at the anode chamber outlet is directed to an anolyte buffer tank.

27. The method of claim 23, wherein the aqueous sodium hydroxide solution produced at the cathode chamber outlet is directed to a catholyte buffer tank.

28. The method of claim 23, wherein the aqueous hypochlorous acid is free from metal cations, periodate, phosphate buffers, carbonate buffers, and organic compounds with halogen stabilizing abilities.

29. The method of claim 23, wherein the method does not include titration.

30. The method of claim 23, wherein the method does not use any acid as an input component.

31. The method of claim 23, wherein the aqueous hypochlorous acid has a Raman spectroscopy peak in a range of 720 centimeters⁻¹-740 centimeters⁻¹ when characterized by Raman spectroscopy.

32. The method of claim 23, wherein a pH balance of the aqueous hypochlorous acid is controllable using one or more of the feedback controlled water pressure, a feedback controlled electric current, a feedback controlled sodium chloride, and a feedback controlled sodium hydroxide.

33. The method of claim 23, wherein parts per million (PPM) of the HOCl in the aqueous hypochlorous acid is controllable using one or more of the feedback controlled water pressure, a feedback controlled electric current, a feedback controlled sodium chloride, and a feedback controlled sodium hydroxide.

34. The method of claim 23, wherein a salt concentration of the aqueous hypochlorous acid is controllable using one or more of the feedback controlled water pressure, a feedback controlled electric current, a feedback controlled sodium chloride, and a feedback controlled sodium hydroxide.

35. The method of claim 23, wherein an oxidative reduction potential (ORP) of the aqueous hypochlorous acid is controllable using one or more of the feedback controlled water pressure, a feedback controlled electric current, a feedback controlled sodium chloride, and a feedback controlled sodium hydroxide.

36. The method of claim 23, wherein an amount of free chlorine concentration in the aqueous hypochlorous acid is controllable using one or more of the feedback controlled water pressure, a feedback controlled electric current, a feedback controlled sodium chloride, and a feedback controlled sodium hydroxide.

37. The method of claim 23, wherein hydrogen gas is expressed at the cathode chamber outlet of the electrolysis chamber, and a chlorine and oxygen gas mixture are expressed at the anode chamber outlet of the electrolysis chamber.

38. The method of claim 37, wherein the hydrogen gas is approximately 1000:1 air to hydrogen mixture, and safe to vent.

39. The method of claim 37, wherein the chlorine and oxygen gas mixture is exchanged in a closed system which includes activated carbon block adsorption filters.

40. The method of claim 39, wherein the activated carbon block adsorption filters are monitored by a chlorine sensor.

41. The method of claim 23, further comprising:
obtaining a pH value from input water prior to the input water entering the electrolysis chamber;
adjusting the pH value of the input water prior to the input water entering the electrolysis chamber; and
modulating pH values of the aqueous hypochlorous acid that is produced by the system using the pH value adjustment of the input water in conjunction with adjustment of the sodium hydroxide input levels.

42. An electrolysis method, comprising:
controlling water flow rate into an electrolysis chamber using water pressure;
applying current to the electrolysis chamber via a power supply;
adding sodium chloride brine to an anode chamber inlet and creating an aqueous mixture;
adding sodium hydroxide to the aqueous mixture; and
producing aqueous hypochlorous acid from the electrolysis chamber, wherein the aqueous hypochlorous acid is free from hypochlorites, phosphates, oxides, and stabilizers.

43. The method of claim 42, further comprising:
obtaining a pH value from input water prior to the input water entering the electrolysis chamber;
adjusting the pH value of the input water prior to the input water entering the electrolysis chamber; and
modulating pH values of the aqueous hypochlorous acid that is produced by the system using the pH value adjustment of the input water in conjunction with adjustment of the sodium hydroxide input levels and adjustment of the water flow rate.

44. An electrolysis system using a deployable, remote-controlled manufacturing system, the system comprising:
a monitoring system that monitors sensors in the system;
a communication system that transmits data from the monitored sensors and receives instructions; and
a control system including a processor and a memory storing computer instructions that, when executed by the processor with the received instructions, cause the processor to:
control water flow rate into an electrolysis chamber, by providing feedback controlled water pressure;
apply feedback controlled current to the electrolysis chamber via an adjustable and high-current power supply;
add sodium chloride brine, via a feedback controlled actuator, to an anode chamber inlet and creating an aqueous mixture;
add sodium hydroxide, via the feedback controlled actuator, to the aqueous mixture; and
produce aqueous hypochlorous acid at an anode chamber outlet, and aqueous sodium hydroxide solution at a cathode chamber outlet, wherein the aqueous hypochlorous acid is free from hypochlorites, phosphates, oxides, and stabilizers.

45. The system of claim 44, wherein a control system including a processor and a memory storing further computer instructions that, when executed by the processor, cause the processor to:
obtain a pH value from input water prior to the input water entering the electrolysis chamber;
adjust the pH value of the input water prior to the input water entering the electrolysis chamber; and
modulate pH values of the aqueous hypochlorous acid that is produced by the system using the pH value adjustment of the input water in conjunction with adjustment of the sodium hydroxide input levels.

46. An electrolysis system using a deployable, remote-controlled manufacturing system, the system comprising:
one or more deployable, remote-controlled manufacturing systems, each deployable, remote-controlled manufacturing system comprising:
a monitoring system that monitors sensors in the system;
a communication system that transmits data from the monitored sensors and receives instructions; and
a control system including a processor and a memory storing computer instructions that, when executed by the processor with the received instructions, cause the processor to:
control water flow rate into an electrolysis chamber, by providing feedback controlled water pressure;
apply feedback controlled current to the electrolysis chamber via an adjustable and high-current power supply;
add sodium chloride brine, via a feedback controlled actuator, to an anode chamber inlet and creating an aqueous mixture;
add sodium hydroxide, via the feedback controlled actuator, to the aqueous mixture; and
produce aqueous hypochlorous acid at an anode chamber outlet, and aqueous sodium hydroxide solution at a cathode chamber outlet, wherein the aqueous hypochlorous acid is free from hypochlorites, phosphates, oxides, and stabilizers; and
a basecamp unit comprising:
a monitoring system that monitors the one or more deployable, remote-controlled manufacturing systems;
a communication system that transmits data to and from the one or more deployable, remote-controlled HOCl manufacturing systems; and
a control system including a processor and a memory storing computer instructions that, when executed by the processor with received instructions, cause the processor to:
receive information from the one or more deployable, remote-controlled manufacturing systems; and
send instructions to the one or more deployable, remote-controlled manufacturing systems.

47. The system of claim 46, wherein a control system including a processor and a memory storing further computer instructions that, when executed by the processor, cause the processor to:
obtain a pH value from input water prior to the input water entering the electrolysis chamber;
adjust the pH value of the input water prior to the input water entering the electrolysis chamber; and
modulate pH values of the aqueous hypochlorous acid that is produced by the system using the pH value adjustment of the input water in conjunction with adjustment of the sodium hydroxide input levels.

48. A deployable, remote-controlled, hypochlorous acid (HOCl) electrolysis manufacturing system, the system comprising:
a water supply tank from which water is obtained;
a brine water supply tank from which brine water is obtained;
an electrolysis chamber having an anolyte chamber inlet, a catholyte chamber inlet, an anode chamber outlet, and a cathode chamber outlet;
a conduit from the water supply tank to a catholyte metering valve of the electrolysis chamber;
a conduit from the brine water supply tank to an anolyte metering valve of the electrolysis chamber;
a supply pump associated with the conduit from the water supply tank to the catholyte metering valve of the electrolysis chamber;
a saline metering pump associated with the conduit from the brine water supply tank to the anolyte metering valve of the electrolysis chamber;
a high-current power supply that applies current to the electrolysis chamber; and
a control system including a processor and a memory storing computer instructions that, when executed by the processor, cause the processor to:
control water flow rate into the electrolysis chamber, by providing feedback controlled water pressure;
apply feedback controlled current to the electrolysis chamber via an adjustable and high-current power supply;
add sodium chloride brine, via a feedback controlled actuator, to an anode chamber inlet and create an aqueous mixture; and
add sodium hydroxide, via the feedback controlled actuator, to the aqueous mixture,
wherein aqueous hypochlorous acid is produced at the anode chamber outlet, and aqueous sodium hydroxide solution is produced at the cathode chamber outlet, wherein the aqueous hypochlorous acid is free from hypochlorites, phosphates, oxides, and stabilizers.

49. The system of claim 48, wherein a control system including a processor and a memory storing further computer instructions that, when executed by the processor, cause the processor to:
obtain a pH value from input water prior to the input water entering the electrolysis chamber;
adjust the pH value of the input water prior to the input water entering the electrolysis chamber; and
modulate pH values of the aqueous hypochlorous acid that is produced by the system using the pH value adjustment of the input water in conjunction with adjustment of the sodium hydroxide input levels.

50. A deployable, remote-controlled, hypochlorous acid (HOCl) electrolysis manufacturing system, the system comprising:
an electrolysis chamber;
a high-current power supply that applies current to the electrolysis chamber; and
a control system including a processor and a memory storing computer instructions that, when executed by the processor, cause the processor to:
control water flow rate into the electrolysis chamber, by providing feedback controlled water pressure;
apply feedback controlled current to the electrolysis chamber via an adjustable and high-current power supply;
add sodium chloride brine, via a feedback controlled actuator, to an anode chamber inlet and create an aqueous mixture; and
add sodium hydroxide, via the feedback controlled actuator, to the aqueous mixture,
wherein aqueous hypochlorous acid is produced from the electrolysis chamber, wherein the aqueous hypochlorous acid is free from hypochlorites, phosphates, oxides, and stabilizers.

51. The system of claim 50, wherein a control system including a processor and a memory storing further computer instructions that, when executed by the processor, cause the processor to:
obtain a pH value from input water prior to the input water entering the electrolysis chamber;
adjust the pH value of the input water prior to the input water entering the electrolysis chamber; and
modulate pH values of the aqueous hypochlorous acid that is produced by the system using the pH value adjustment of the input water in conjunction with adjustment of the sodium hydroxide input levels and adjustment of the water flow rate.

52-67. (canceled)

68. An electrolysis system using a deployable, remote-controlled manufacturing system, the system comprising:
a monitoring system that monitors sensors in the system;
a communication system that transmits data from the monitored sensors and receives instructions; and
a control system that incorporate one or more of artificial neural networks and machine learning models, the control system including a processor and a memory storing computer instructions that, when executed by the processor with the received instructions, cause the processor to:
control water flow rate into an electrolysis chamber, by providing machine learning feedback controlled water pressure;
apply machine learning feedback controlled current to the electrolysis chamber via an adjustable and high-current power supply;
add sodium chloride brine, via a machine learning feedback controlled actuator, to an anode chamber inlet and creating an aqueous mixture;
add sodium hydroxide, via the machine learning feedback controlled actuator, to the aqueous mixture;
monitor multiple, linked effects of each control parameter in real time to identify and modify constantly changing control parameters; and
produce aqueous hypochlorous acid, wherein the aqueous hypochlorous acid is free from hypochlorites, phosphates, oxides, and stabilizers;
wherein the one or more of artificial neural networks and machine learning models utilize a combination of ML algorithms and real-time closed loop adaptive learning controls to adjust multiple feedback control loops in relation to each other.

69. The system of claim 68, wherein the one or more artificial neural networks and machine learning models access a set of machine learning models based on historic production data that influence the one or more artificial neural networks and real time machine learning models, wherein the one or more artificial neural networks and machine learning models control multiple feedback control loop cycles and enable the system to self-correct and adapt for changes in the HOCl generation process during a production run.

70. The system of claim 68, wherein the combination of machine learning algorithms and real-time closed loop adaptive learning controls include particle swarm optimization.

71. The system of claim 68, wherein the one or more artificial neural networks and machine learning models predict future behavior of the pH adjustment parameters and perform real-time control of the pH adjustment loops, electrolysis current, and brine.

72. The method of claim 68, wherein the electrolysis chamber utilizes dynamic vortex implosion inputs that are injected into a laminar flow plenum.

73. The method of claim 72, wherein the laminar flow plenum is alternating platinum and ruthenium-iridium oxide encased.

74. An electrolysis method using a hypochlorous acid (HOCl) manufacturing system, the method comprising:
accessing a control system that incorporates one or more of artificial neural networks and machine learning models, the control system including a processor and a memory storing computer instructions;
controlling water flow rate into an electrolysis chamber, by providing feedback controlled water pressure;
applying feedback controlled current to the electrolysis chamber via an adjustable and high-current power supply;
adding sodium chloride brine, via a feedback controlled actuator, to an anode chamber inlet and creating an aqueous mixture;
adding sodium hydroxide, via the feedback controlled actuator, to the aqueous mixture;
monitoring multiple, linked effects of each control parameter in real time to identify and modify constantly changing control parameters; and
producing aqueous hypochlorous acid, wherein the aqueous hypochlorous acid is free from hypochlorites, phosphates, oxides, and stabilizers;
wherein the one or more of artificial neural networks and machine learning models utilize a combination of machine learning algorithms and real-time closed loop adaptive learning controls to adjust multiple feedback control loops in relation to each other.

75. The method of claim 74, wherein the one or more artificial neural networks and machine learning models access a set of machine learning models based on historic production data that influence the one or more artificial neural networks and real time machine learning models, wherein the one or more artificial neural networks and machine learning models control multiple feedback control loop cycles and enable the system to self-correct and adapt for changes in the HOCl generation process during a production run.

76. The method of claim 74, wherein the combination of machine learning algorithms and real-time closed loop adaptive learning controls include particle swarm optimization.

77. The method of claim 74, wherein the one or more artificial neural networks and machine learning models predict future behavior of the pH adjustment parameters and perform real-time control of the pH adjustment loops, electrolysis current, and brine.

78. The method of claim 74, wherein the electrolysis chamber utilizes dynamic vortex implosion inputs that are injected into a laminar flow plenum.

79. The method of claim 78, wherein the laminar flow plenum is alternating platinum and ruthenium-iridium oxide encased.
